(19) United States
(12) Patent Application Publication
(10) Pub. No.: US 2017/0293297 A1
(43) Pub. Date: Oct. 12, 2017

(54) ELECTRONIC APPARATUS AND OPERATING METHOD THEREOF

(71) Applicant: Samsung Electronics Co., Ltd., Gyeonggi-do (KR)

(72) Inventors: Seung-Nyun KIM, lncheon (KR); Youn Lea KIM, Seoul (KR); Byoung-Uk YOON, Gyeonggi-do (KR); So-Young LEE, Gyeonggi-do (KR); In-Hyuk CHOI, Seoul (KR); Chang-Ryong HEO, Gyeonggi-do (KR)

(73) Assignee: Samsung Electronics Co., Ltd.

(21) Appl. No.: 15/482,085

(22) Filed: Apr. 7, 2017

(30) Foreign Application Priority Data
Apr. 7, 2016 (KR) 10-2016-0042897

(51) Int. Cl. G05D 1/00; G06K 9/00; B64D 47/08; H04N 7/18; G08C 17/02; B64C 39/02

(52) U.S. Cl. CPC G05D 1/0038; G08C 17/02; B64C 39/024; B64D 47/08; G05D 1/0016; G05D 1/0088; G05D 1/0094; H04N 7/183; G06K 9/0063; G08C 2201/93; B64C 2201/127; B64C 2201/024; B64C 2201/108

(57) ABSTRACT

An operating method of an external imaging device is provided which includes establishing a wireless connection with an electronic device comprising a display using a wireless communication device, receiving a parameter from the electronic device through the wireless connection, the parameter determined based on at least part of at least one photo and information, controlling a navigation device to autonomously fly to a set position based on the parameter, capturing an image using the camera, and sending the image to the electronic device through the wireless connection.

### PRIORITY

The present application priority under 35 U.S.C. §119(a) to Korean Patent Application Serial No. 10-2016-0042897 which was filed in the Korean Intellectual Property Office on Apr. 7, 2016, the entire disclosure of which is incorporated herein by reference.

### BACKGROUND

### 1. Field of the Disclosure

The present disclosure relates generally to an electronic apparatus for unmanned photographing, and a method thereof.

### 2. Description of the Related Art

An unmanned electronic device may be wirelessly connected to and remotely controlled by a remote controller (RC). The unmanned electronic device including a camera may enable photo/video image capturing in order to take a picture. To capture a photo/video image at an intended position, the unmanned electronic device may be controlled through the RC to take a picture.

The electronic device enabling the unmanned photographing may be an unmanned aerial vehicle (UAV) or a drone including a plurality of propellers.

A photographing method using the UAV may take a picture while moving the UAV to an intended position through an external electronic device (e.g., an RC or a smart phone). However, when a user is not familiar with the control of the unmanned electronic device or wants to take a picture while moving the unmanned photographing device, the user may experience difficulty in photographing at the intended position.

### SUMMARY

An aspect of the present disclosure is to provide an apparatus and method of an electronic device for taking a selfie image of intended composition at a user's intended position.

Another aspect of the present disclosure is to provide an apparatus and a method of an unmanned electronic device for autonomously taking a picture based on a user's preference in association with a mobile communication device.

According to an aspect of the present disclosure, an electronic device is provided which includes a housing, a display unit exposed through at least part of the housing, at least one wireless communication unit, a processor electrically connected to the display and the communication circuit, and a memory electrically connected to the processor. The memory may store one or more photos. The memory may store instructions, which when executed, cause the processor to display one or more photos on the display, to receive a user input indicating a preference of at least one photo, to store information about the preference in the memory, to determine at least one parameter based on at least part of the at least one photo and the information, to send the at least one parameter to an external imaging device through the wireless communication unit so as to autonomously fly to a set position based on part of the at least one parameter, and to receive an image captured at the position from the external imaging device.

According to another aspect of the present disclosure, an external imaging device is provided which includes a housing, a navigation device attached to or integrated with the housing, at least one wireless communication device, a camera attached to or integrated with the housing, a processor electrically connected to the navigation device, the communication device, and the camera, and a memory electrically connected to the processor and storing instructions which when executed cause the processor to establish a wireless connection with an external electronic device comprising a display using the wireless communication device, receive a parameter from the external electronic device through the wireless connection, the parameter determined based on at least part of at least one photo and information, control the navigation device to autonomously fly to a set position based on the parameter, capture an image using the camera, and send the image to the external electronic device through the wireless connection.

According to another aspect of the present disclosure, an operating method of an electronic device includes displaying one or more photos on a display, receiving a user input indicating a preference of at least one photo, storing information about the preference in a memory, determining at least one parameter based on at least part of the at least one photo and the information, sending the at least one parameter to an external imaging device through a wireless communication unit so as to autonomously fly to a set position based on part of the at least one parameter, and receiving an image captured at the position from the external imaging device.

According to another aspect of the present disclosure, an operating method of an external imaging device includes establishing a wireless connection with an external electronic device comprising a display using the wireless communication device, receiving a parameter from the external electronic device through the wireless connection, the parameter determined based on at least part of at least one photo and information, controlling the navigation device to autonomously fly to a set position based on the parameter, capturing an image using the camera, and sending the image to the external electronic device through the wireless connection.

### BRIEF DESCRIPTION OF THE DRAWINGS

The above and other aspects, features, and advantages of the present disclosure will be more apparent from the following description taken in conjunction with the accompanying drawings, in which:

FIG. 1 is a block diagram of an electronic device in a network environment according to an embodiment of the present disclosure;

FIG. 2 is a block diagram of an electronic device according to an embodiment of the present disclosure;

FIG. 3 is a block diagram of a program module according to an embodiment of the present disclosure;

FIG. 4 is a block diagram of an electronic device according to an embodiment of the present disclosure;

FIG. 5 is a block diagram of an unmanned photographing device according to an embodiment of the present disclosure;

FIG. 6 is a diagram illustrating a method for automatic photographing using an unmanned photographing device according to an embodiment of the present disclosure;

FIG. 7 is a block diagram of an unmanned photographing device according to an embodiment of the present disclosure;

FIG. 8 is a diagram of a platform structure of an unmanned photographing device according to an embodiment of the present disclosure;

FIGS. 9A, 9B, 9C and 9D are diagrams of a structure and driving operation of an unmanned photographing device according to an embodiment of the present disclosure;

FIGS. 10A, 10B and 10C illustrate movement control of an unmanned photographing device using an electronic device according to an embodiment of the present disclosure;

FIG. 11 is a flow diagram of a photographing method of an unmanned photographing device according to an embodiment of the present disclosure;

FIG. 12 is a flowchart of a method for processing photographing information in an electronic device according to an embodiment of the present disclosure;

FIGS. 13A and 13B are diagrams of images based on a photographing position of an unmanned photographing device according to an embodiment of the present disclosure;

FIG. 14 is a flowchart of a method for determining a preference of an image by selecting the image in an electronic device according to an embodiment of the present disclosure;

FIGS. 15A and 15B are screenshots of an electronic device which sets a preference of a selected image according to an embodiment of the present disclosure;

FIG. 16 is a flowchart of a method for determining an object preference of a selected image in an electronic device according to an embodiment of the present disclosure;

FIG. 17 is a flowchart of a method for updating a photographing position in an electronic device according to an embodiment of the present disclosure;

FIGS. 18A and 18B are screenshots of an electronic device which sets an image preference according to an embodiment of the present disclosure;

FIG. 19 is a flowchart of a method for setting preference in association with a network service in an electronic device according to an embodiment of the present disclosure;

FIG. 20A is a flowchart of a method for setting photographing information by collecting information of a network service in an electronic device according to an embodiment of the present disclosure;

FIG. 20B is a flowchart of a method for transmitting an image and photographing information in a network service according to an embodiment of the present disclosure;

FIGS. 21A and 21B are screenshots of an electronic device which generates photographing information by changing metadata of an image according to an embodiment of the present disclosure;

FIGS. 22A, 22B, 22C and 22D are diagrams of an electronic device which sets a plurality of photographing positions using a three-dimensional (3D) application according to an embodiment of the present disclosure;

FIG. 23 is a flowchart of operations of an unmanned photographing device according to an embodiment of the present disclosure;

FIG. 24 is a flowchart of automatic photographing operations of an unmanned photographing device according to an embodiment of the present disclosure;

FIG. 25 is a flowchart of automatic photographing operations of an unmanned photographing device according to another embodiment of the present disclosure;

FIG. 26 is a diagram of an unmanned photographing device which photographs by changing composition in a center focus mode according to an embodiment of the present disclosure;

FIG. 27 is a flowchart of operations of an unmanned photographing device which photographs by including an additional object according to an embodiment of the present disclosure;

FIG. 28 is a diagram of an unmanned photographing device which photographs when an additional object is included according to an embodiment of the present disclosure;

FIG. 29 is a flowchart of operations of an unmanned photographing device which photographs under an abnormal photographing condition according to an embodiment of the present disclosure; and

FIG. 30 is a diagram of an unmanned photographing device which photographs by considering a light source according to an embodiment of the present disclosure.

Throughout the drawings, like reference numerals will be understood to refer to like parts, components and structures.

### DETAILED DESCRIPTION

Hereinafter, certain embodiments of the present disclosure will be described with reference to the accompanying drawings. However, it should be understood that there is no limiting of the present disclosure to the particular forms disclosed herein; rather, the present disclosure should be understood to cover various modifications, equivalents, and/or alternatives of embodiments of the present disclosure. In describing the drawings, similar reference numerals may be used to designate similar constituent elements.

As used herein, the expressions “have”, “may have”, “include”, or “may include” refer to the existence of a corresponding feature (e.g., numeral, function, operation, or constituent element such as component), and do not exclude one or more additional features.

In the present disclosure, the expressions “A or B”, “at least one of A or/and B”, or “one or more of A or/and B” may include all possible combinations of the items listed. For example, the expressions “A or B”, “at least one of A and B”, or “at least one of A or B” refers to all of (1) including at least one A, (2) including at least one B, or (3) including all of at least one A and at least one B.

The expressions “a first”, “a second”, “the first”, or “the second” as used in an embodiment of the present disclosure may modify various components regardless of the order and/or the importance but do not limit the corresponding components. For example, a first user device and a second user device indicate different user devices although both of them are user devices. For example, a first element may be referred to as a second element, and similarly, a second element may referred to as a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. In contrast, it may be understood that when an element (e.g., first element) is referred to as being “directly connected,” or “directly coupled” to another element (second element), there are no elements (e.g., third element) interposed between them.

The expression “configured to” as used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer to a situation in which the device, together with other devices or components, “is able to”. For example, the phrase “processor adapted (or configured) to perform A, B, and C” may refer, for example, to a dedicated processor (e.g. embedded processor) only for performing the corresponding operations or a general-purpose processor (e.g., central processing unit (CPU) or application processor (AP)) that may perform the corresponding operations by executing one or more software programs stored in a memory device.

The terms used in the present disclosure are only used to describe specific embodiments, and do not limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even where a term is defined in the present disclosure, it should not be interpreted to exclude embodiments of the present disclosure.

An electronic device according to an embodiment of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device, and the like, but is not limited thereto. The wearable device may include at least one of an accessory type (e.g., a watch, a ring, a bracelet, an anklet, a necklace, a glasses, a contact lens, or a head-mounted device (HIVID)), a fabric or clothing integrated type (e.g., an electronic clothing), a body-mounted type (e.g., a skin pad, or tattoo), and a bio-implantable type (e.g., an implantable circuit), and the like, but is not limited thereto.

According to an embodiment of the present disclosure, the electronic device may be a home appliance. The home appliance may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, and the like, but is not limited thereto.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic device for a ship (e.g., a navigation device for a ship, and a gyro-compass), avionics, security devices, an automotive head unit, a robot for home or industry, an automatic teller machine (ATM), a point of sales (POS) terminal, or an Internet of things (IoT) device (e.g., a light bulb, various sensors, electric or gas meter, a sprinkler device, a fire alarm, a thermostat, a streetlamp, a toaster, a sporting good, a hot water tank, a heater, a boiler, etc.), and the like, but is not limited thereto.

According to an embodiment of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter), and the like, but is not limited thereto. The electronic device may be a combination of one or more of the aforementioned various devices. The electronic may be a flexible device. Further, the electronic device is not limited to the aforementioned devices, and may include a new electronic device according to the development of new technology.

Hereinafter, an electronic device according to an embodiment of the present disclosure will be described with reference to the accompanying drawings. As used herein, the term “user” may indicate a person who uses an electronic device or a device (e.g., an artificial intelligence electronic device) that uses an electronic device.

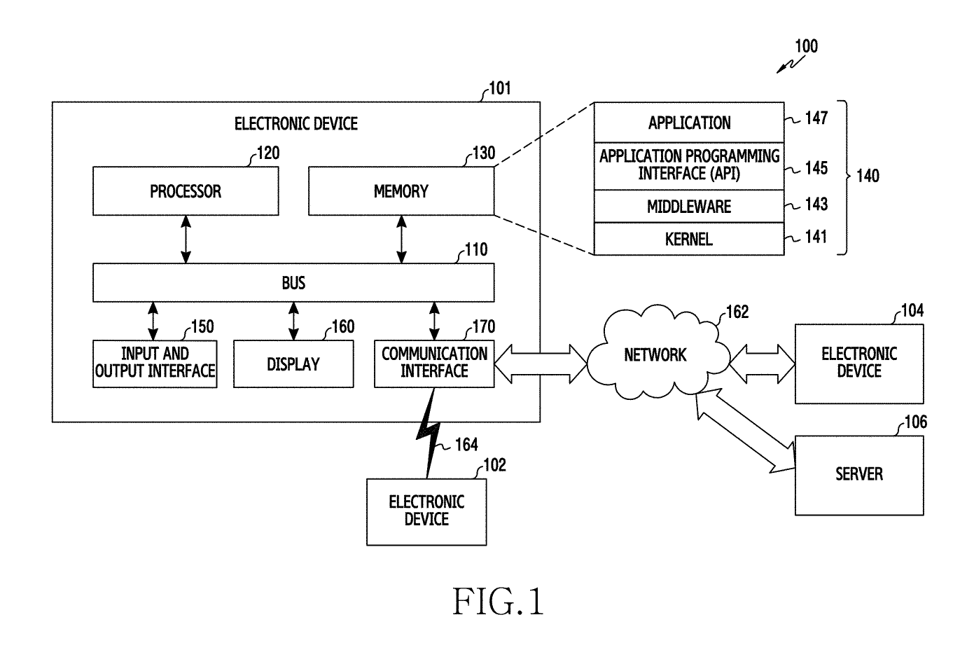

FIG. 1 illustrates a network environment including an electronic device according to an embodiment of the present disclosure.

An electronic device 101 within a network environment 100, according to an embodiment of the present disclosure, will be described with reference to FIG. 1. The electronic device 101 includes a bus 110, a processor 120, a memory 130, an input/output interface 150, a display 160, and a communication interface 170. The electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a central processing unit (CPU), an application processor (AP), and a communication processor (CP). The processor 120 may carry out, for example, calculation or data processing relating to control and/or communication of at least one other component of the electronic device 101. An operation of processing (or controlling) the processor 120 according to an embodiment of the present disclosure will be described below in detail with reference to the accompanying drawings.

The memory 130 may include a volatile memory and/or a non-volatile memory. The memory 130 may store, for example, commands or data relevant to at least one other component of the electronic device 101. According to an embodiment of the present disclosure, the memory 130 stores software and/or a program 140. The program 140 includes, for example, a kernel 141, middleware 143, an application programming interface (API) 145, and/or application programs (or “applications”) 147. At least some of the kernel 141, the middleware 143, and the API 145 may be referred to as an operating system (OS). The memory 130 may include a computer readable recording medium having a program recorded thereon to execute the method in the processor 120.

The kernel 141 may control or manage system resources (e.g., the bus 110, the processor 120, or the memory 130 ) used for performing an operation or function implemented in the other programs (e.g., the middleware 143, the API 145, or the applications 147 ). Furthermore, the kernel 141 may provide an interface through which the middleware 143, the API 145, or the applications 147 may access the individual components of the electronic device 101 to control or manage the system resources.

The middleware 143, for example, may serve as an intermediary for allowing the API 145 or the applications 147 to communicate with the kernel 141 to exchange data.

The middleware 143 may process one or more task requests received from the applications 147 according to priorities thereof. For example, the middleware 143 may assign priorities for using the system resources (e.g., the bus 110, the processor 120, the memory 130, and the like) of the electronic device 101, to at least one of the applications 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a light-emitting diode (LED) display, an organic light-emitting diode (OLED) display, a microelectromechanical Systems (MEMS) display, and an electronic paper display, and the like, but is not limited thereto. The display 160 may display, for example, various types of content (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and a first external electronic device 102, a second external electronic device 104, or a server 106. For example, the communication interface 170 may be connected to a network 162 through wireless or wired communication, and may communicate with the second external electronic device 104 or the server 106.

The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth™, near field communication (NFC), and global navigation satellite system (GNSS). GNSS may include, for example, at least one of global positioning system (GPS), global navigation satellite system (Glonass), Beidou navigation satellite system (Beidou) or Galileo, and the European global satellite-based navigation system, based on a location, a bandwidth, and the like. Hereinafter, in the present disclosure, the term “GPS” may be interchangeably used with the term “GNSS”. The wired communication may include, for example, at least one of a universal serial bus (USB), a high definition multimedia interface (HDMI), recommended standard 232 (RS-232), and a plain old telephone service (POTS).

The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. All or some of the operations performed in the electronic device 101 may be executed in another electronic device or the electronic devices 102 and 104 or the server 106. When the electronic device 101 has to perform some functions or services automatically or in response to a request, the electronic device 101 may request the electronic device 102 or 104 or the server 106 to execute at least some functions relating thereto instead of or in addition to autonomously performing the functions or services. The electronic device 102 or 104, or the server 106 may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

For example, the server 106 may include at least one of a certification server, an integration server, a provider server (or a mobile network operator server), a content server, an Internet server, or a cloud server.

In an embodiment of the present disclosure, the first external electronic device 102 and/or the second external electronic device 104 may be unmanned photographing devices. The unmanned photographing device may include an unmanned aerial vehicle or uninhabited aerial vehicle (UAV), an unmanned vehicle or robot, and so on.

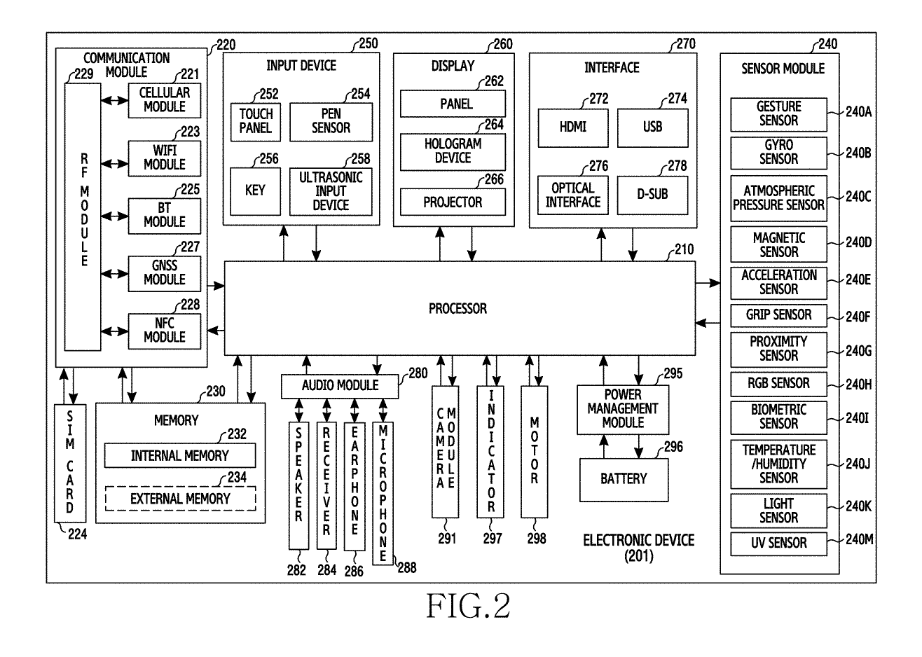

FIG. 2 is a block diagram of an electronic device according to an embodiment of the present disclosure.

The electronic device 201 includes, for example, all or a part of the electronic device 101 shown in FIG. 1. The electronic device 201 includes one or more processors 210 (e.g., application processors (AP)), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of data and calculations. The processor 210 may be embodied as, for example, a system on chip (SoC). According to an embodiment of the present disclosure, the processor 210 may further include a graphic processing unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal to or similar to that of the communication interface 170 of FIG. 1. The communication module 220 includes, for example, the cellular module 221, a Wi-Fi module 223, a BT module 225, a GNSS module 227 (e.g., a GPS module 227, a Glonass module, a Beidou module, or a Galileo module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using subscriber identification module (SIM) card 224. The cellular module 221 may perform at least some of the functions that the AP 210 may provide. The cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the Wi-Fi module 223, the BT module 225, the GNSS module 227, and the NFC module 228 may transmit/receive an RF signal through a separate RF module.

The SIM card 224 may include, for example, a card including a subscriber identity module and/or an embedded SIM, and may contain unique identification information (e.g., an integrated circuit card identifier (ICCID)) or subscriber information (e.g., an International mobile subscriber identity (IMSI)).

The memory 230 (e.g., the memory 130 ) includes, for example, an embedded memory 232 and/or an external memory 234. The embedded memory 232 may include at least one of a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, a solid state drive (SSD), and the like).

The external memory 234 may further include a flash drive, for example, a compact flash (CF), a secure digital (SD), a micro secure digital (Micro-SD), a mini secure digital (Mini-SD), an eXtreme Digital (xD), a multimediacard (MMC), a memory stick, and the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 includes, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 2400 a color sensor 240H (e.g., red, green, and blue (RGB) sensor), a biometric sensor (medical sensor) 2401, a temperature/humidity sensor 240J, an illuminance (e.g., light) sensor 240K, and a ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, and without limitation, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone 288, ultrasonic waves generated by an input tool, and identify data corresponding to the detected ultrasonic waves.

The display 260 (e.g., the display 160) includes a panel 262, a hologram device 264, or a projector 266.

The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 includes, for example, and without limitation, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an image signal processor (ISP) or a flash (e.g., LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual charge quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, and the like) of the electronic device 201 or a part (e.g., the processor 210) of the electronic device 201. The motor 298 may convert an electrical signal into a mechanical vibration, and may generate a vibration, a haptic effect, and the like. The electronic device 201 may include a processing device (e.g., a GPU) for supporting a mobile TV. The processing device for supporting a mobile TV may process, for example, media data according to a certain standard such as digital multimedia broadcasting (DMB), digital video broadcasting (DVB), or MediaFlo™.

Each of the above-described component elements of hardware according to an embodiment of the present disclosure may be configured with one or more components, and the names of the corresponding component elements may vary based on the type of electronic device. The electronic device may include at least one of the above-described elements. Some of the above-described elements may be omitted from the electronic device, or the electronic device may further include additional elements. Also, some of the hardware components may be combined into one entity, which may perform functions identical to those of the relevant components before the combination.

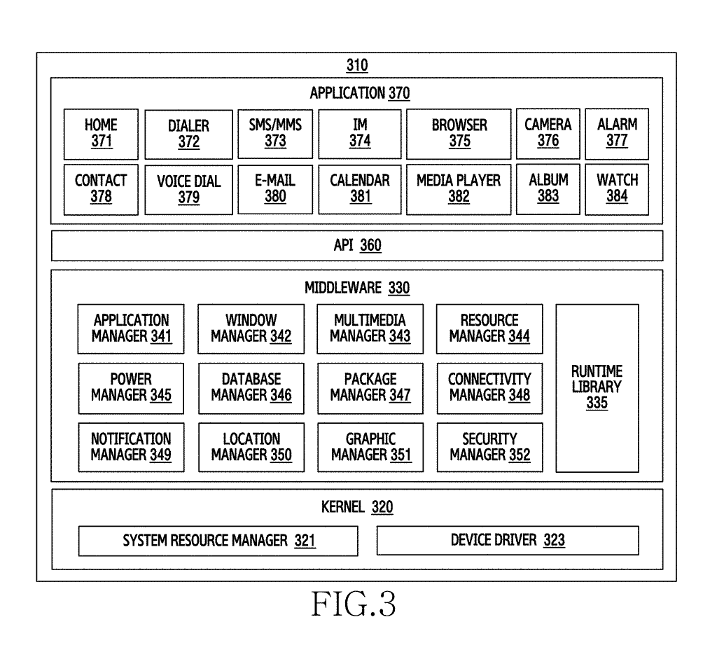

FIG. 3 is a block diagram of a program module according to an embodiment of the present disclosure.

According to an embodiment of the present disclosure, the program module 310 (e.g., the program 140) includes an operating system (OS) for controlling resources related to the electronic device 101 and/or various applications (e.g., the application programs 147) executed in the operating system. The operating system may be, for example, Android™, iOS™, Windows™, Symbian™, Tizen™, Bada™, and the like.

The program module 310 includes a kernel 320, middleware 330, an API 360, and/or applications 370. At least some of the program module 310 may be preloaded on an electronic device, or may be downloaded from the electronic device 102 or 104, or the server 106.

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) includes at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, and the like.

The application manager 341 may manage, for example, a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a basic input/output system (BIOS) and the like to manage a battery or power source and may provide power information and the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, and the like. According to an embodiment of the present disclosure, when the electronic device 101 has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android™ or iOS™, one API set may be provided for each platform. In the case of Tizen™, two or more API sets may be provided for each platform.

The applications 370 (e.g., the application programs 147) include, for example, one or more applications which may provide functions such as a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, a watch 384 and the like. The application 370 may include an application for providing a health care (e.g., for measuring exercise quantity or blood sugar level, etc.), or environment information (e.g., providing atmospheric pressure, humidity, or temperature information), an authentication application for authenticating an electronic device, and the like.

According to an embodiment of the present disclosure, the applications 370 may include an information exchange application that supports exchanging information between the electronic device 101 and the electronic device 102 or 104. The information exchange application may include, for example, a notification relay application for transferring specific information to an external electronic device or a device management application for managing an external electronic device.

For example, the notification relay application may include a function of transferring, to the electronic device 102 or 104, notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of the electronic device 102 or 104 communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance and the like) designated according to attributes of the electronic device 102 or 104. The applications 370 may include an application received from the server 106, or the electronic device 102 or 104. The applications 370 may include a preloaded application or a third party application that may be downloaded from a server. The names of the components of the program module 310 may change according to the type of operating system.

According to an embodiment of the present disclosure, at least a part of the programming module 310 may be implemented in software, firmware, hardware, or a combination of two or more thereof. At least some of the program module 310 may be implemented (e.g., executed) by, for example, the processor 120. At least some of the program module 310 may include, for example, a module, a program, a routine, a set of instructions, and/or a process for performing one or more functions.

The term “module” as used herein may, for example, refer to a unit including one of hardware, software, and firmware or a combination of two or more of them. The term “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of a dedicated processor, a CPU, an application-specific integrated circuit (ASIC) chip, a field-programmable gate array (FPGA), and a programmable-logic device for performing operations which has been known or are to be developed hereinafter.

According to an embodiment of the present disclosure, at least some of the devices (for example, modules or functions thereof) or the method (for example, operations) may be implemented by a command stored in a computer-readable storage medium in a programming module form. The instruction, when executed by a processor 120, may cause the one or more processors to execute the function corresponding to the instruction. The computer-readable recording media may be, for example, the memory 130.

The computer readable recording medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like. In addition, the program instructions may include high level language codes, which may be executed in a computer by using an interpreter, as well as machine codes made by a compiler. The aforementioned hardware device may be configured to operate as one or more software modules in order to perform the operation of the present disclosure, and vice versa.

Any of the modules or programming modules according to an embodiment of the present disclosure may include at least one of the above described elements, exclude some of the elements, or further include other additional elements. The operations performed by the modules, programming module, or other elements may be executed in a sequential, parallel, repetitive, or heuristic manner. Further, some operations may be executed according to another order or may be omitted, or other operations may be added.

In an embodiment of the present disclosure to be described below, a hardware approach will be described as an example. However, since the present disclosure includes a technology using both hardware and software, the present disclosure does not exclude a software-based approach.

According to an embodiment of the present disclosure, an electronic device may generate photographing information by reflecting a user's preference in association with an application, and an unmanned photographing device may automatically move to a photographing position according to the photographing information and capture an image of a subject. The electronic device may take, receive, and store an image having photographing information including three-dimensional position information. A user of the electronic device may create the photographing information based on the preference. The electronic device may send the photographing information to the unmanned photographing device. The unmanned photographing device may automatically move to a photographing position according to the photographing information in an auto photographing mode and automatically capture an image of a subject at the photographing position.

According to an embodiment of the present disclosure, the term “unmanned photographing device” may indicate an unmanned mobile device including a camera. The unmanned photographing device may include a UAV, an unmanned vehicle, a robot, and the like. The term “auto photographing” may indicate that the unmanned photographing device photographs by automatically moving to a target photographing position based on a subject in a photographing mode. The unmanned photographing device may be an external imaging device. The term “preference-based information” is photographing information preferred by the user, and may be collected through various user interface (UI)/user experience (UX) such as an album of the electronic device. The preference-based photographing information may be collected over a network. The term “complex image information” may include an image and its related photographing information. The term “photographing information” may include metadata, photographing position information, screen composition information, and/or camera control information. The photographing information may be used as a parameter. The term “parameter” may be information for the unmanned photographing device to capture an image. The term “photographing position information” may be position information for the unmanned photographing device to automatically capture an image of a subject. The photographing position information may include a three-dimensional absolute coordinate value based on the subject. The term “composition information” may include screen composition information including the subject. The term “camera control information” may include information for controlling a camera angle such that the camera of the unmanned photographing device faces the subject in the auto photographing mode.

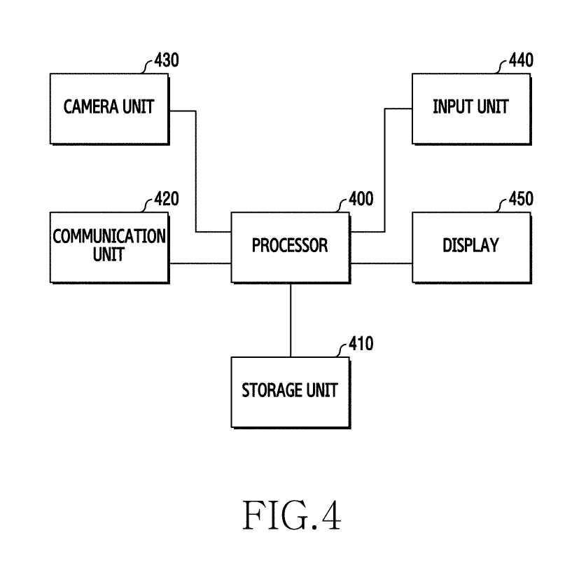

FIG. 4 is a block diagram of an electronic device according to an embodiment of the present disclosure.

Referring to FIG. 4, an electronic device according to an embodiment of the present disclosure includes a processor 400, a storage unit 410, a camera unit 430, a communication unit 420, an input unit 440, and a display 450.

The processor 400 may be the processor 120 of FIG. 1 or the processor 210 of FIG. 2. The processor 400 may create photographing information for automatic photography of an unmanned photographing device. The photographing information may include photographing position information after the unmanned photographing device automatically moves. The photographing information may include at least one of the photographing position information of the unmanned photographing device, screen composition information including an image of a subject, and camera information for controlling a camera angle such that a camera of the unmanned photographing device faces the subject.

The processor 400 may generate the photographing information according to a preference set by a user. When a stored photo is selected, the processor 400 may display a UI/UX for selecting the user's preference and configure the photographing information based on the preference set by the user. The processor 400 may receive photographing information based on the preference of other users through network communication (e.g., social network service (SNS)). The processor 400 may send an image captured by the unmanned photographing device to a network system (e.g., an SNS server) and receive photographing information including preference information of the other users. The processor 400 may analyze photographing information in the network system and receive photographing information based on the preference of the other users.

The storage unit 410 may be the memory 130 of FIG. 1 or the memory 230 of FIG. 2. The storage unit 410 may store complex image information taken by the unmanned photographing device. The storage unit 410 may store complex image information including the photographing information received through the network communication. The storage unit 410 may store complex image information including photographing information updated by the processor 400 based on the preference. The complex image information may be information including an image and its photographing information.

The communication unit 420 may include the entity of or a part of the communication interface 170 of FIG. 1 and the communication module 220 of FIG. 2. The communication module 420 may transmit information for controlling movement of the unmanned photographing device. The communication module 420 may receive path information according to the movement of the unmanned photographing device. The communication module 420 may send the photographing information to the unmanned photographing device. The communication module 420 may receive the image captured by the unmanned photographing device and its photographing information.

The camera unit 430 may include the entire or part of the input/output interface 150 of FIG. 1 and the camera module 291 of FIG. 2. The camera unit 430 may include a lens, an image sensor, an image signal processor, and a camera controller. The image sensor may include a row driver, a pixel array, and a column driver. The image signal processor may include an image preprocessor, an image postprocessor, a still image codec, and a video codec. The image signal processor may be included in the processor 400.

The input unit 440 may include the entire or part of the input/output interface 150 of FIG. 1 and the input device 250 of FIG. 2. The input unit 440 may input an input and data to control operations of the electronic device. The input unit 440 may include a touch panel. The input unit 440 may further include a (digital) pen sensor. The input unit 440 may further include key buttons.

The display 450 may include the display 160 of FIG. 1 and the display 260 of FIG. 2. The display 450 may include a liquid crystal display (LCD) or a light emitting diode (LED) display. The LED display may include an organic LED (OLED) and an active matrix OLED (AMOLED).

The input unit 440 and the display 450 may comprise an integral touch screen. The touch screen may display a screen under control of the processor 400, and detect touch, gesture, proximity, or hovering input using a digital pen or a user's body part.

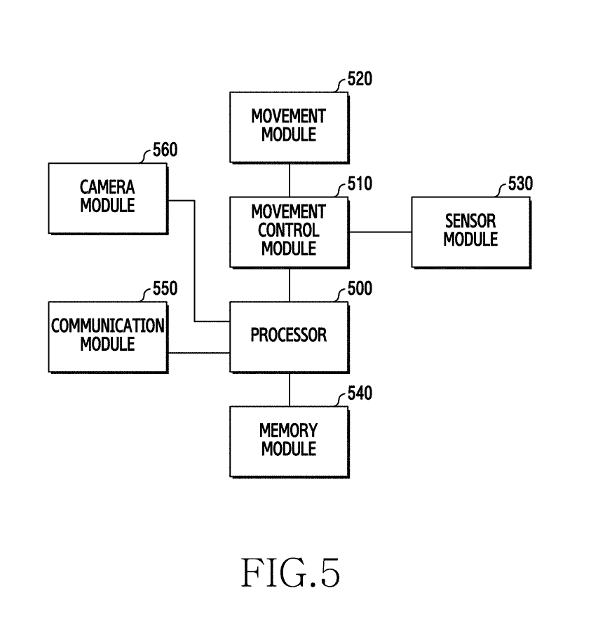

FIG. 5 is a block diagram of an unmanned photographing device according to an embodiment of the present disclosure.

Referring to FIG. 5, the unmanned photographing device may include a processor 500 (or an application processing module), a movement control module 510, a movement module 520, a sensor module 530, a memory module 540, a communication module 550, and a camera module 560. The unmanned photographing device according to an embodiment of the present disclosure may be an external imaging device.

The processor 500 may, for example, process an operation or data in relation to controlling of one or more components of the unmanned photographing device and/or application execution. The processor 500 may automatically move the unmanned photographing device to a photographing position by executing an auto photography application, and automatically capture an image of a subject at the photographing position. When the photographing ends, the processor 500 may control the unmanned photographing device to return to an original position (e.g., a photographing start position). The processor 500 may send photograph information including the captured image and the image photographing position information, to the electronic device. The processor 500 may be the application processing module of the unmanned photographing device.

The movement control module 510 may control movement of the unmanned photographing device using position and attitude information of the unmanned photographing device. The movement control module 510 may include an attitude control module. The movement control module 510 may obtain attitude information and/or position information acquired by the attitude control module (e.g., an attitude and heading reference system), a GPS module of the communication module 550, and the sensor module 530.

When the unmanned photographing device is a UAV, the movement control module 510 may be a flight control module. The flight control module may control roll, pitch, yaw, and throttle of the UAV according to the position and attitude information acquired by the attitude control module. The movement control module 510 may control a hovering operation, and automatically fly the unmanned photographing device to a target point based on the photographing position information provided to the processor 500. The photographing position information may be in the form of three-dimensional coordinates.

The movement module 520 may move the unmanned photographing device under the control of the movement control module 510. When the unmanned photographing device is a drone, the movement module 520 may include motors which drive propellers.

The movement control module 510 and the movement module 520 according to an embodiment of the present disclosure may be a navigation device.

The sensor module 530 may measure a physical amount or detect an operation state of the unmanned photographing device, and thus convert the measured or detected information to an electric signal. The sensor module 530 may include all or part of an acceleration sensor, a gyro sensor, a barometer, a terrestrial magnetism sensor or compass sensor, an ultrasonic sensor, an optical sensor for detecting movement using images, a temperature-humidity sensor, an illuminance sensor, a UV sensor, and a gesture sensor.

The sensor module 530 according to an embodiment of the present disclosure may include sensors for controlling (or calculating) the attitude of the unmanned photographing device. The sensors for controlling (or calculating) the attitude of the unmanned photographing device may include the gyro sensor and the acceleration sensor. To calculate an azimuth and to prevent drift of the gyro sensor, the sensor module 530 may combine outputs of a terrestrial magnetism sensor.

The memory module 540 may include a volatile memory and/or a non-volatile memory. The memory module 540 may store commands or data of at least one other component of the unmanned photographing device. The memory module 540 may store software and/or programs. The programs may include a kernel, a middleware, an API, and/or an application program (or application). At least part of the kernel, the middleware, or the API may be referred to as an operating system (OS).

The memory module 540 according to an embodiment of the present disclosure may store the photographing information including the position information to capture the image of the subject in the auto photographing mode. The photographing information may include at least one of the photographing position information, screen composition information, and camera control information.

The communication module 550 may include at least one of a wireless communication module and a wired communication module. The wireless communication module may include a cellular communication module and a short-range communication module. The communication module 550 may include a GPS module.

The cellular communication module may use at least one of LTE, LTE-A, CDMA, WCDMA, UMTS, WiBro, and GSM.

The short-range communication module may include at least one of Wi-Fi, Bluetooth, NFC, and GNSS or GPS. The GNSS may include, for example, at least one of GPS, global navigation satellite system (GLONASS), Beidou navigation satellite system (Beidou), or Galileo (the European global satellite-based navigation system), according to its use area or bandwidth. Hereafter, the term GNSS may be interchangeably used with the term GPS.

The wired communication module may include, for example, at least one of USB, HDMI, and RS-232.

The GPS module according to an embodiment of the present disclosure may output position information such as longitude, latitude, altitude, speed, and heading information of the UAV during the movement of the unmanned photographing device. The position information may calculate the position by measuring accurate time and distance using the GPS module. The GPS module may acquire not only the longitude, the latitude, and the altitude, but also the three-dimensional speed information and the accurate time.

The communication module 550 may transmit information for checking real-time movement of the unmanned photographing device. The communication module 550 may receive photographing information from the electronic device. The communication module 550 may transmit the image taken by the unmanned photographing device and the photographing information, to the electronic device.

The camera module 560 may capture an image of a subject in the auto photographing mode. The camera module 560 may include a lens, an image sensor, an image signal processor, and a camera controller. The image signal processor may be included in the processor 500 (or AP module).

The lens may focus using straightness and refraction of light and zoom in/out of an image of a subject.

The image sensor may have a structure of a complementary metal oxide semiconductor (CMOS) or a charge coupled device (CCD), and such image sensors may include a pixel array, row control and a readout of the pixel array. The pixel array may include a micro lens array, a color filter array, and light-sensitive element arrays. For example, color filters of the color filter array may be arranged in a Bayer pattern. The image sensor may be controlled using a global shutter or a rolling shutter. Analog pixel signals read from the pixel array of the image sensor may be converted to digital data through an analog to digital converter (ADC). The converted digital data may be output to the outside (e.g., the image signal processor) through an external interface such as mobile industry processor interface (MIPI) via a digital block of the image sensor.

The image signal processor may include an image preprocessor and an image postprocessor. The image preprocessor may perform auto white balance (AWB), auto exposure (AE), auto focusing (AF) extraction and processing, lens shading correction, dead pixel correction, and knee correction on subframe images. The image postprocessor may include a color interpolator, an image processing chain (IPC), and a color converter. The color interpolator may interpolate color of the image-preprocessed subframe images. The IPC may cancel noise and correct color of the color-interpolated images. The color convertor may convert red, green, blue (RGB) data to luminance (Y), blue-luminance (U), red-luminance (V) YUV data.

The image signal processor may include an encoder for encoding the processed images and a decoder for decoding the encoded image. The encoder and the decoder may include a still image codec for encoding and decoding a still image and/or a moving image codec for encoding and decoding a moving image.

The image signal processor may scale (e.g., resize) the processed high-resolution image to an adequate resolution (e.g., a display resolution) and output the image on a display. Using the image processing result, the image signal processor may control (e.g., AF, AE, AWB, IPC, face detection, object tracking, etc.) of the camera module and/or the image signal processor including the image sensor.

The camera controller may include a lens controller for controlling the lens, and a direction controller for controlling a camera direction (up, down, left, and/or right directions). The lens controller may zoom, focus, and control an iris diaphragm by controlling the lens. The direction controller may control the angle for vertical and horizontal directions of the camera so as to face an image of a subject.

The camera module 560 may be a gimbal camera. The gimbal camera may include a gimbal and a camera. The gimbal may stabilize the unmanned photographing device without vibration and shake of the unmanned photographing device. Upon arriving at a target position, the camera may automatically take a picture in the auto photographing mode under the control of the processor 500. Based on camera control information output from the processor 500 in the auto photographing mode, the camera may adjust the camera angle such that the camera lens faces an image of a subject.

The unmanned photographing device may include a UAV, an unmanned vehicle, and/or a robot. The UAV may be piloted by ground control without a pilot aboard or autonomously fly according to a pre-input program or by recognizing an environment (e.g., obstacle, path, etc.) by itself. The UAV may include a movement control module, and the movement control module may include a flight control module and an attitude control module.

The unmanned photographing device according to an embodiment of the present disclosure may be the UAV. The unmanned photographing device may be a device including the camera module in the UAV. In the following description, the unmanned photographing device is the UAV by way of example.

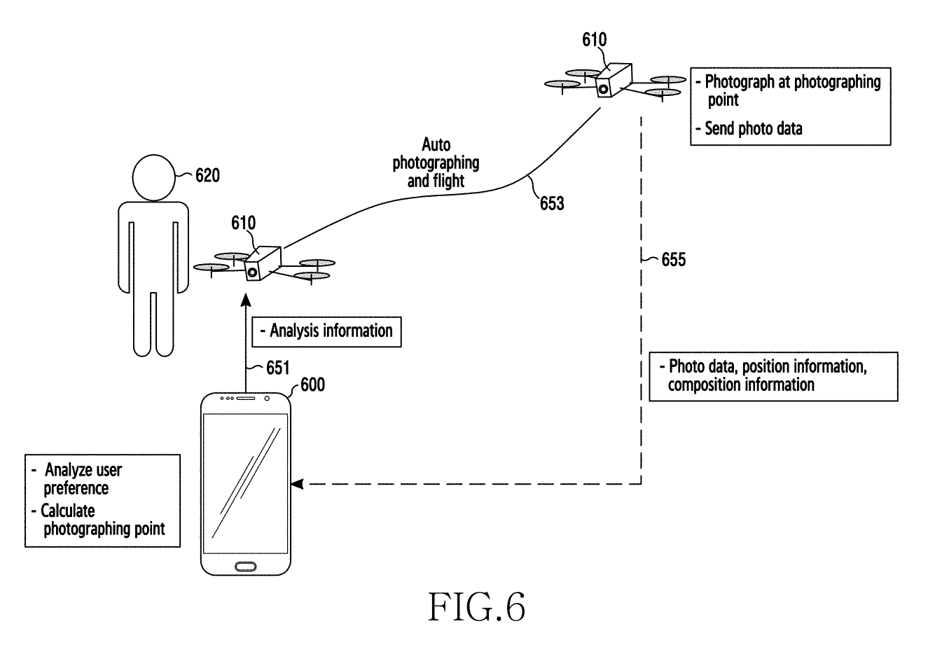

FIG. 6 is a diagram illustrating a method for automatic photographing using an unmanned photographing device according to an embodiment of the present disclosure.

Referring to FIG. 6, an unmanned photographing device 610 according to an embodiment of the present disclosure may automatically capture an image of a subject 620 based on photographing information received from an electronic device 600. The unmanned photographing device 610 may be connected to a separate RC by radio or by wire, and move under control of the RC. The RC may be the electronic device of FIG. 4.

A user may see a preview image or a live image captured by the unmanned photographing device 610 through the electronic device 600. Upon viewing the preview image through the electronic device 600, the user may take an intended image. According to an embodiment of the present disclosure, the user may independently control the movement and the camera of the unmanned photographing device 610 using a plurality of electronic devices. For example, with two electronic devices, two users may control the movement and the camera of the unmanned photographing device 610. The electronic device 600 and the unmanned photographing device 610 are linked, and touching of the electronic device 600 in the photography may control the movement (e.g., pitch/roll control of the drone) of the unmanned photographing device 610.

The electronic device 600 may communicate with the unmanned photographing device 610 and set an operation mode of the unmanned photographing device 610. According to an embodiment of the present disclosure, the electronic device 600 may set the auto photographing mode of the unmanned photographing device 610. The unmanned photographing device 610 may include an external input interface for setting the photographing mode of the camera module 560. The auto photography may indicate that the unmanned photographing device 610 automatically moves to a photographing position determined by the electronic device 600 and automatically capture the subject 620 at the photographing position.

The unmanned photographing device 610 according to an embodiment of the present disclosure may enter a selfie camera mode. The selfie camera mode may allow the user to take his/her own picture. In the selfie mode, the captured image of the subject 620 may vary according to an angle. Accordingly, to optimize the angle in the selfie camera mode, the camera angle may be adjusted in various manners. The unmanned photographing device 610 may move to a preset photographing position in the auto photographing mode and then automatically capture the subject 620. The auto photographing mode may include the selfie camera mode.

According to an embodiment of the present disclosure, the electronic device 600 may generate photographing information. The photograph information may be generated based on user preference. The photographing information based on the user preference may be generated by a user's selection. For example, the information based on the user preference may be generated in a manner that the user directly sets the preference in the image or uploads the image to a network such as an SNS.

The electronic device 600 may collect preference of others in association with the network service such as an SNS, or collect photographing information of other electronic devices from a server.

The electronic device 600 may generate the photographing information using a 3D application allowing simulations.

The preference-based photographing information may include at least one of a user's favorite photographing position, screen composition (e.g., an image of a subject position in the screen), and the camera angle (e.g., the photographing angle of the camera).

According to an embodiment of the present disclosure, the electronic device 600 may set the auto photographing mode in the unmanned photographing device 610 and send the photographing information in operation 651. The electronic device 600 may send the photographing information in operation 651, and the unmanned photographing device 610 may set the auto photographing mode based on the received photographing operation. Upon receiving the photographing information including the photographing position, the unmanned photographing device 610 may hover around and identify the subject 620 and move to the photographing position for the auto shooting in operation 653. The moved coordinate value (e.g., an X coordinate, a Y coordinate, a Z coordinate) after the hovering may be the photographing position information. After moving to the target photographing position, the unmanned photographing device 610 may capture the subject 620. Next, the unmanned photographing device 610 may send complex image information including the captured image and the photographing information to the electronic device 600 in operation 655. The photographing information sent from the unmanned photographing device 610 to the electronic device 600 may include metadata (e.g., in an exchangeable image file format (exif)), the photographing position information, the composition information, and/or the camera angle information.

The unmanned photographing device 610 may receive the photographing information from the electronic device 600. In the auto photographing mode, the unmanned photographing device 610 may hover around in order to recognize the subject 620. After recognizing the subject, the unmanned photographing device may determine the subject position as the reference point and fly from the determined reference point to the photographing position of the photographing information in step 653. Upon arriving at the photographing position, the unmanned photographing device may capture the subject 620 and transmit the captured image and the photographing information to the electronic device 600 in step 655. The photographing information transmitted to the electronic device may include the photographing position information of the unmanned photographing device.

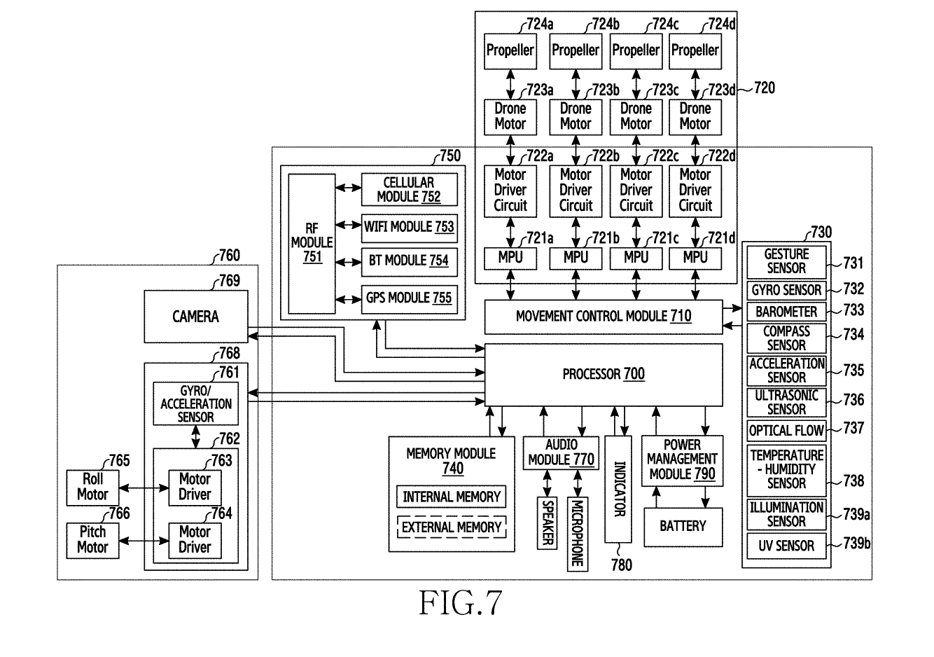

FIG. 7 is a block diagram of an unmanned photographing device according to an embodiment of the present disclosure. In FIG. 7, the unmanned photographing device may be a quadcopter.

Referring to FIG. 7, a processor 700 (or application processing module) may be the processor 500 of FIG. 5. The processor 700 may control the auto photographing mode based on the received photographing information. The photographing information may include the photographing position information. The photographing information may include the composition information and/or the camera control information. The photographing information may be based on the user preference in the electronic device. The processor 700 may send the photographing position information to a movement control module 710 and control the movement of the unmanned photographing device. The processor 700 may send driving and/or camera control information to a camera module 760 and control the composition and the angle of the camera and a subject.

The movement control module 710 may be the movement control module 510 of FIG. 5. The movement control module 710 may control the movement of the unmanned photographing device using position and attitude information of the unmanned photographing device. When the unmanned photographing device is a UAV, the movement control module 710 may include a flight control module and an attitude control module. The flight control module may control roll, pitch, yaw, and throttle of the UAV according to position and attitude information acquired by the attitude control module. The movement control module 710 may control hovering, and automatically fly the unmanned photographing device to a target point based on photographing position information received from the processor 700. The processor 700 may be an application processing module of the unmanned photographing device.

The movement module 720 may be the movement module 520 of FIG. 5. In the quadcopter, the movement module 720 includes microprocessor units (MPUs) 721 a through 721d, motor drivers 722a through 722d, motors 723a through 723d, and propellers 724a through 742d. The MPUs 721a through 721d may output control data for rotating the corresponding propellers 724a through 742 d based on the photographing position information output from the movement control module 710. The motor drivers 722a through 722d may convert the motor control data output from the MPUs 721a through 721d to motor driving signals. The motors 723a through 723d may control the corresponding propellers 724a through 742d to rotate based on the driving signals of the motor drivers 722a through 722d.

In an embodiment of the present disclosure, the movement control module 710 and the movement module 720 may be a navigation device. The movement module 720 in the auto photographing mode may fly the unmanned photographing device to the photographing position based on the control of the movement control module 710.

A sensor module 730 may be the sensor module 530 of FIG. 5. The sensor module 730 includes all or some of a gesture sensor 731 for detecting a motion and/or a gesture of an image of a subject, a gyro sensor 732 for measuring an angular velocity of the flying unmanned photographing device, a barometer 733 for measuring a pressure change and/or an atmospheric pressure of the air, a terrestrial magnetism sensor/compass sensor 734 for measuring terrestrial magnetism, an acceleration sensor 735 for measuring acceleration of the flying unmanned photographing device, an ultrasonic sensor 736 for measuring a distance by outputting ultrasonic waves and detecting a signal reflected by an object, an optical sensor 737 for calculating a position by detecting geographical features or pattern on the ground using the camera module, a temperature-humidity sensor 738 for measuring temperature and humidity, an illuminance sensor 739a for measuring illuminance, and a UV sensor 739b for measuring ultra-violet light.

The sensor module 730 may calculate the attitude of the unmanned photographing device. The sensor for calculating the attitude of the unmanned photographing device may be the gyro sensor 732 and the acceleration sensor 735. To calculate an azimuth and to prevent drift of the gyro sensor 732, the output of the terrestrial magnetism sensor/compass sensor 734 may be combined.

A memory module 740 includes an internal memory and an external memory. The memory module 740 may be the memory module 540 of FIG. 5. The memory module 740 may store commands or data of at least one other component of the unmanned photographing device. The memory module 740 may store software and/or program. The program may include a kernel, a middleware, an API, and/or an application program (or application).

The memory module 740 may store the photographing information including the position information of an image of a subject to capture in the auto photographing mode. The photographing information may include at least one of the photographing position information, the screen composition information, and the camera control information.

A communication module 750 may be the communication module 510 of FIG. 5. The communication module 750 may include at least one of a wireless communication module and a wired communication module. The communication module 750 includes an RF module 751, a cellular module 752, Wi-Fi module 753, a BT module 754, and a GPS module 755.

The GPS module 755 may output position information such as longitude, latitude, altitude, speed, and heading information of the UAV during the movement of the unmanned photographing device. The position information may calculate the position by measuring accurate time and distance using the GPS module 755. The GPS module 755 may acquire the longitude, the latitude, the altitude, and the three-dimensional speed information and the accurate time.

The communication module 750 may send information for checking real-time movement of the unmanned photographing device. The communication module 750 may receive photographing information from the electronic device. The communication module 750 may transmit the image captured by the unmanned photographing device and the photographing information, to the electronic device.

A camera module 760 includes a camera 769 and a gimbal 768. The gimbal 768 may include a gimbal controller 762, a gyro/acceleration sensor 761, motor driver 763 and 764, and motors 765 and 766. The camera module 760 may be the camera module 560 of FIG. 5.

The camera 769 may take a picture in the auto photographing mode. The camera module 760 may include a lens, an image sensor, an image signal processor, and a camera controller. The camera controller may control composition and/or a camera angle (photographing angle) of an image of a subject by adjusting vertical and horizontal angles of the camera lens based on the composition information and/or the camera control information output from the processor 700.

The camera 769 may be affected by the movement of the unmanned photographing device. The gimbal 768 may take a stable image at a fixed angle of the camera 769 regardless of the movement of the unmanned photographing device.

In the operation of the gimbal 768, the sensor 761 may recognize the movement of the unmanned photographing device. The sensor 761 may include a gyro sensor and an acceleration sensor. The gimbal controller 762 may recognize the movement of the unmanned photographing device by analyzing a measurement value of the sensor 761 including the gyro sensor and the acceleration sensor. The gimbal controller 762 may generate compensation data according to the movement of the unmanned photographing device. The compensation data may control the pitch and the roll of the camera module 760. The gimbal 768 may send the roll compensation data to the motor driver 763, and the motor driver 763 may convert the roll compensation data to a motor driving signal and send the motor driving signal to the roll motor 765. The gimbal 768 may send the pitch compensation data to the motor driver 764, and the motor driver 764 may convert the pitch compensation data to a motor driving signal and send the motor driving signal to the roll motor 766. The roll motor 765 and the pitch motor 766 may correct the roll and the pitch of the camera module 760 according to the movement of the unmanned photographing device. Hence, the camera 769 may balance the rotation (e.g., the pitch and the roll) of the unmanned photographing device (e.g., a multicopter) by means of the gimbal 768 and thus stabilize the camera 769.

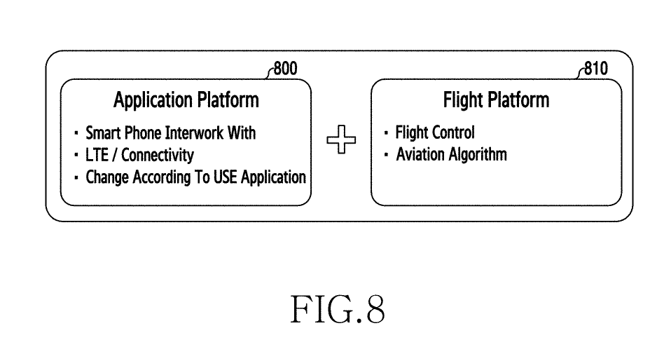

FIG. 8 is a diagram of a platform structure of an unmanned photographing device according to an embodiment of the present disclosure. For example, the unmanned photographing device may be a drone.

The unmanned photographing device may fly using a plurality of propellers. The propeller may turn by a force of a motor. Depending on the number of rotors (the number of propellers), a drone with four rotors may be referred to as a quadcopter, a drone with six rotors may be referred to as a hexacopter, and a drone with eight rotors may be referred to as an octocopter.

Referring to FIG. 8, the unmanned photographing device may include an application platform 800 and a flight platform 810. The application platform 800 may interwork with the electronic device, connect communication with the electronic device, and change an operation according to a user application. The application platform 800 may be executed by the processor 700. The flight platform 810 may run flight control and aviation algorithms. The flight platform 810 may be executed by the movement control module 710. The unmanned photographing device may include at least one of the application platform for driving the UAV and providing a service by receiving a control signal using the wireless link with the electronic device, and the flight platform for controlling the flight according to the aviation algorithm.

According to an embodiment of the present disclosure, the unmanned photographing device may be a UAV, and the UAV may include an attitude control module and a GPS module. The attitude control module may include part of the movement control module 510. The attitude control module may measure the attitude, the angular velocity, and the acceleration of the UAV through the sensor module 730. The GPS module 755 may measure the position of the UAV. Output information of the sensor module 730 and the GPS module 755 may be used as basic information for the aviation/automatic control of the UAV.

The attitude control module may be the sensor for calculating the attitude, such as roll and pitch, of the UAV, and may use the gyro sensor 732 and the acceleration sensor 735 of the sensor module 730. The attitude of the UAV may be calculated by measuring the angular velocity of the UAV using the gyro sensor 732 and integrating the measured angular velocity. In so doing, a small error component in the output of the gyro sensor 732 may increase an attitude error through the integration. The attitude control module may compensate for the attitude calculation of the unmanned photographing device using the acceleration sensor 735. In addition, a yaw angle of the unmanned photographing device may be corrected using the output of the terrestrial magnetism sensor/compass sensor 734. In a stationary state, the attitude control module may calculate roll and pitch angles using the output of the acceleration sensor 735. To calculate the azimuth and to prevent drift of the gyro sensor 732, the output of the terrestrial magnetism sensor/compass sensor 734 may be combined.

The sensor module 730 may include the barometer 733 for measuring the altitude using a pressure difference based on the flight of the unmanned photographing device, and the ultrasonic sensor 735 for finely measuring the altitude at a low altitude.

The drone (multicopter) may take a picture/video of a subject. The drone may fly using two principles of lift and torque. A helicopter uses a tail rotor to counteract rotation of a main rotor, whereas the drone may rotate half of multi-rotors clockwise and the other half counterclockwise. 3D coordinates of the drone flight may be determined as pitch (Y), roll (X) and yaw (Z).

The drone may fly by tilting back, forth and horizontally. When the drone is tilted, an air flow direction into the rotor may change. For example, when the drone is leaned forward, the air may flow over and under the drone and go out in a backward direction. Thus, as the air is pushed backward, the drone may fly forward according to the physics of action/reaction. The drone may be tilted by decreasing the speed of the front of the corresponding direction and increasing the speed of the back. Since this method is applied to any direction, the drone may be tilted and moved merely by controlling the rotor speed.

Photography using the drone may be realized in various types (or shots). A crane shot is taken by increasing the altitude from one point to another point. The crane shot may be taken smoothly by slowly moving the drone forward and increasing its velocity. A dolly shot is taken by maintaining the altitude of the drone and moving the drone horizontally. A fly through shot is taken by passing through an obstacle, which may produce visual effects. An orbit shot is taken by flying the drone along a curve and shooting both the inside and the outside of the curve.

In such photography, the drone may shoot downward from above (e.g., vertically downward view). In the selfie camera mode, the drone may fly under, alongside, or over the subject according to the shooting angle. Accordingly, it is necessary to adjust the camera shooting angle in the selfie mode. For example, when capturing a person, it is necessary to adjust the camera angle at a target position.

In the auto photographing mode (e.g., the selfie mode), the camera angle may be adjusted according to the position (height, altitude) of the unmanned photographing device. An eye level may be an angle at which an image of a subject is captured at a user's eye level in a horizontal direction. Since the eye level is similar to a person's normal vision, it may be recognized as natural and no particular distortion or manipulation may be exhibited. A high angle may be used to show the entire situation. For example, the high angle may be a camera angle which looks at an image of a subject down from above. Contrary to the high angle, a low angle may be taken from below an image of a subject (elevation shot).

In an embodiment of the present disclosure, the unmanned photographing device may control the camera according to a position to face the subject.

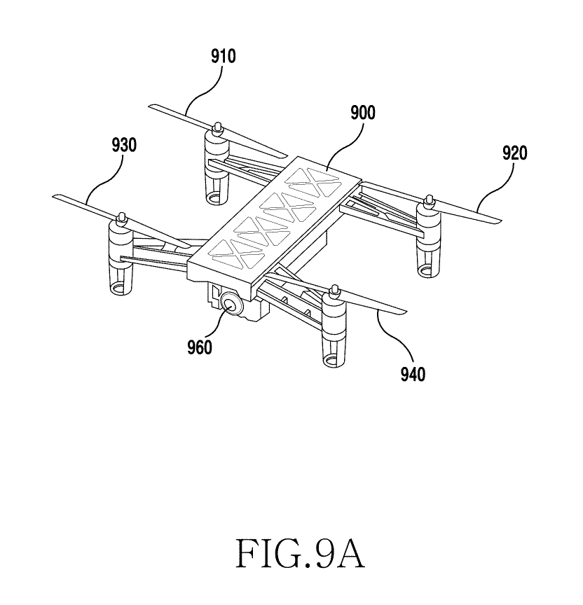

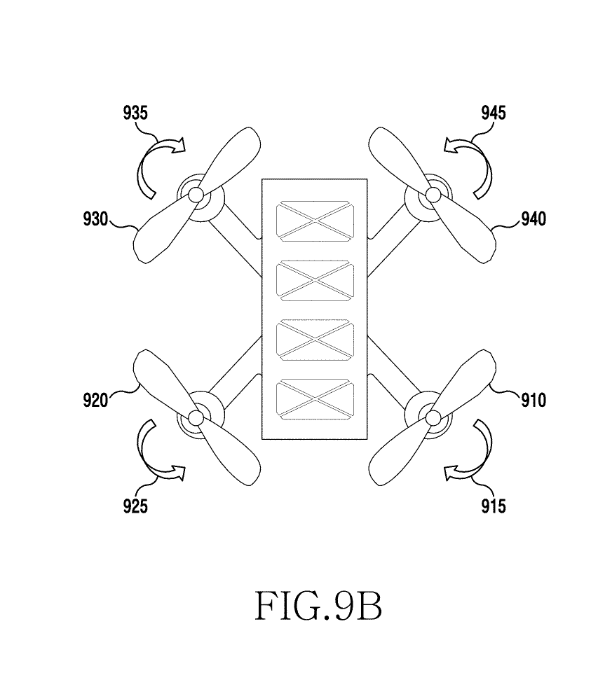

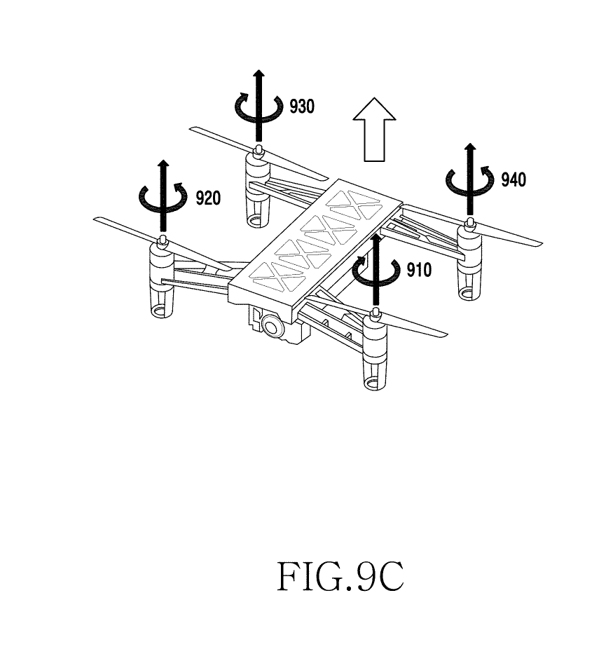

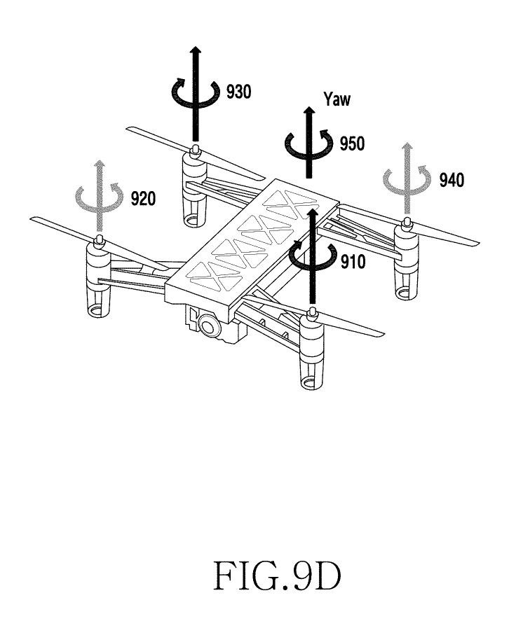

FIGS. 9A, 9B, 9C and 9D are diagrams of a structure and a driving operation of an unmanned photographing device according to an embodiment of the present disclosure.

In FIG. 9A, the unmanned photographing device is a quadcopter drone by way of example. The drone of FIG. 9A includes a main board 900, a gimbal camera 960, and propellers 910 through 940 constructed as shown in FIG. 7. As shown in FIG. 9A, the drone may mount the camera 960 below it and take a picture using the camera during the flight.

FIG. 9B depicts operations of the drone in which opposite propellers may spin in the same direction, and neighboring propellers may spin in the opposite direction. In the quadcopter, two propellers 910 and 930 of the four propellers 910 through 940 may spin clockwise 915 and 935, and the two propellers 920 and 940 may spin counterclockwise 925 and 945. The propellers may spin in different directions to conserve momentum. For example, when the four propellers spin in the same direction, the unmanned photographing device may keep turning in one direction according to the conservation of momentum. The direction change by controlling the rotation speed of the propellers of the drone may also utilize the conservation of momentum.

The movement control module 710 may control the attitude and the flight of the drone. The movement control module 710 may analyze the output of the sensor module 730 and recognize a current state of the drone. The movement control module 710 may utilize the entire or some of the gyro sensor 732 for measuring angular momentum of the drone, the acceleration sensor 735 for measuring angular velocity momentum of the drone, the terrestrial magnetism sensor/compass sensor 734 for measuring terrestrial magnetism of the earth, the barometer 733 for measuring the altitude, and the GPS module 755 for outputting 3D position information of the drone. Based on the measurement information output from the sensor module 730 and the GPS module 755, the movement control module 710 may control the rotation of the propellers 910 through 940 so that the drone may fly in balance.

The movement control module 710 may analyze the measurement results of the sensor module 730 and the GPS module 755 and control the flight of the drone with stability. The drone may move in any direction by increasing the rotational speed of the propeller on the opposite side of an intended direction, which achieves the same effect by lowering the propeller rotational speed of the intended direction. For example, when the movement control module 710 increases the rotational speed of an upper propeller and increases the rotational speed of a lower propeller, the drone may tilt downwards and move. To turn the drone, the movement control module 710 may adjust the rotational speed of two facing propellers, that is, two propellers spinning in the same direction. When the momentum of the propeller spinning in any one direction is predominant, the balance is disrupted and the drone may turn in the opposite direction. For example, when the movement control module 710 increases the rotational speed of the propellers 910 and 930 spinning clockwise, the drone may turn counterclockwise. Also, when the movement control module 710 lowers the rotational speed of all of the propellers, the drone may descend. By increasing the rotational speed, the drone may ascend.

The drone may change direction and move vertically and horizontally in a multidimensional (e.g., 3D) space. For example, a quadcopter drone may control throttle, yaw, pitch, and roll by controlling the rotation of the propellers 910 through 940. The drone may control its movement using four commands as shown in Table 1.

TABLE 1

| Ascend, Descend | Throttle |
|---|---|
| Left direction change, right direction | Yaw |
| change | |
| Forward movement, backward movement | Pitch |
| Left movement, right movement | Roll |

FIGS. 9C and 9D depict examples of movement control of an unmanned photographing device according to an embodiment of the present disclosure. For example, the unmanned photographing device may be the quadcopter drone. The drone may control its flight direction and movement by combining the rotation of the four propellers 910 through 940. For example, when a revolution per minute (RPM) of the four propellers 910 through 940 is increased simultaneously as shown in FIG. 9C, the drone may ascend. When the RPM is decreased at the same time, the drone may descend. Likewise, the drone may move forward by increasing the RPM of the propellers 910 and 920, and move backward by increasing the RPM of the propellers 930 and 940. The drone may move to the left by increasing the RPM of the propellers 910 and 940, and move to the right by increasing the RPM of the propellers 920 and 930. When the opposite propellers 910 and 930 or 920 and 940 are rotated faster than the other two propellers as shown in FIG. 9D, the drone may move to the left or the right.

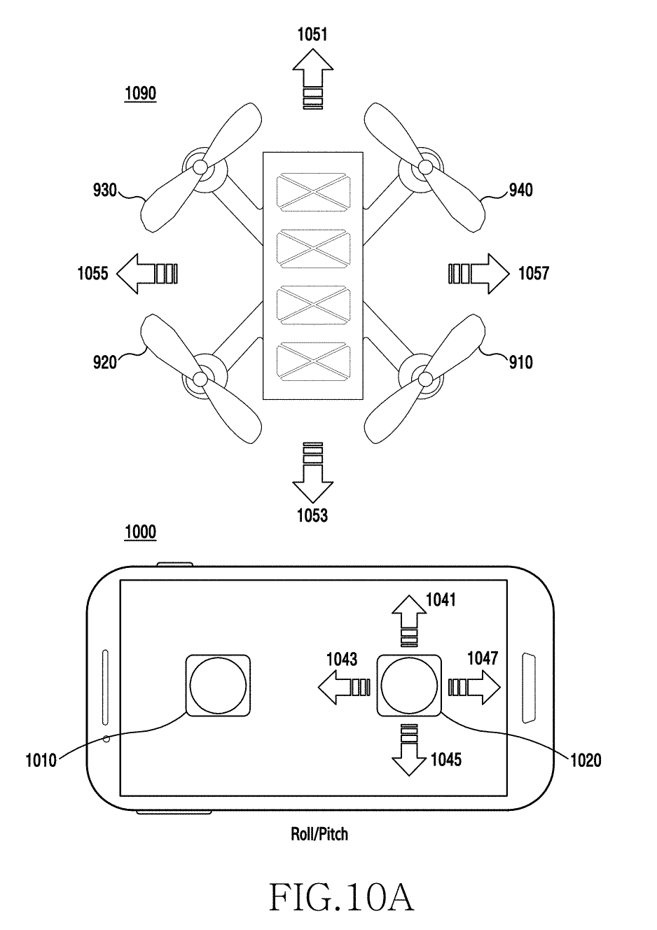

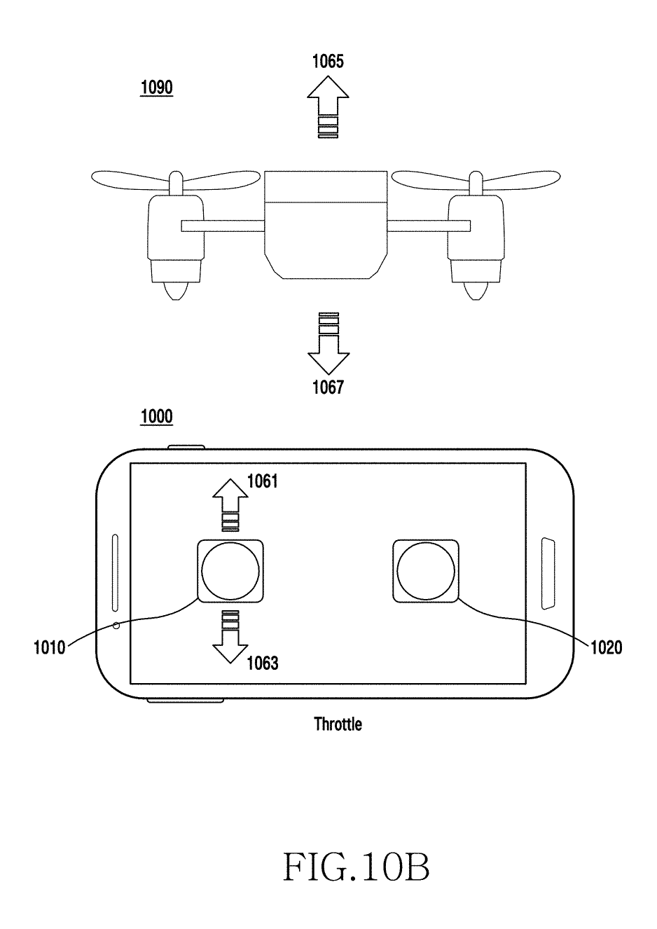

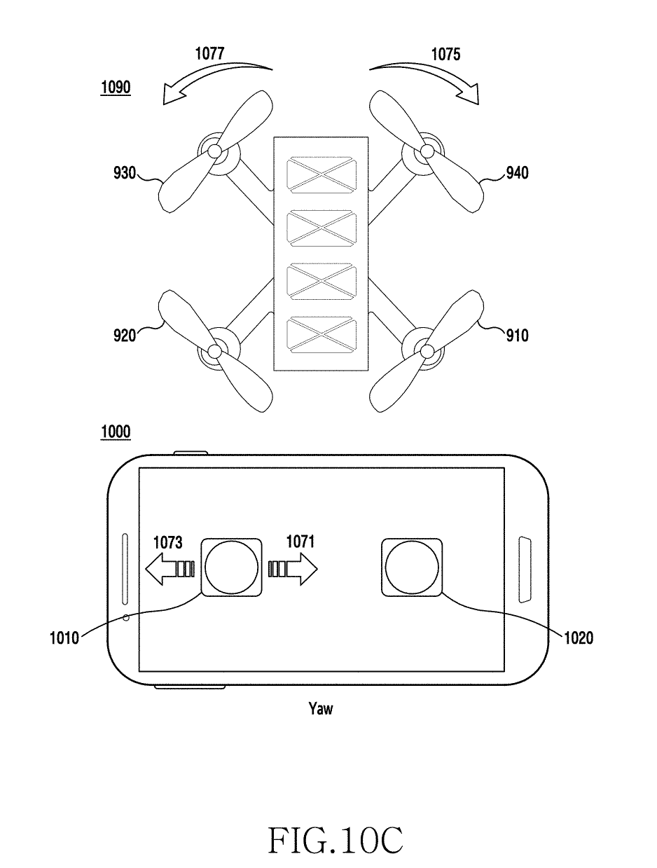

FIGS. 10A, 10B, and 10C illustrate movement control of an unmanned photographing device using an electronic device according to an embodiment of the present disclosure. For example, the unmanned photographing device may be a drone.

Referring to FIG. 10A, the unmanned photographing device 1090 may include a movement control module and a movement module for controlling attitude and flight, and an application processing module (or a processor) for controlling an application of the unmanned photographing device 1090. The movement control module which is a platform hub of the unmanned photographing device 1090, may be connected to various hardware and sensors of the unmanned photographing device 1090 to achieve autonomous flight. The application processing module, which is an application core, may include an OS, provide an API, and provide an application for driving hardware and software by providing an API. The application processing module and the movement control module may include the platform of FIG. 8.

To move the unmanned photographing device 1090 to a particular position (e.g., a target point for the auto photographing, a landing point after the auto photographing), the movement control module may obtain information through the application processing module and execute control to move to a corresponding destination based on the obtained information.

The unmanned photographing device 1090 may be remotely controlled by an electronic device 1000 (e.g., a smart phone).

As shown in FIGS. 10A, 10B, and 10C, the electronic device 1000 may display on the screen 450 a first jog button 1010 and a second jog button 1020 for controlling the movement of the unmanned photographing device 1090. The first jog button 1010 and the second jog button 1020 may be activated by a user touch, and the electronic device 1000 may send a command for controlling the movement of the unmanned photographing device 1090 to the unmanned photographing device 1090 according to a touch-and-drag direction. The application processing module of the unmanned photographing device 1090 may forward the command from the electronic device 1000 to the movement control module, and the movement control module may control the movement of the unmanned photographing device 1090 by controlling the movement module. The first jog button 1010 of the electronic device 1000 may issue throttle and yaw commands, and the second jog button 1020 may issue pitch and roll commands.

FIG. 10A depicts pitch and roll control of the unmanned photographing device 1090. The pitch may indicate the forward and backward movement of the unmanned photographing device 1090, and the roll may indicate the left and right movement of the unmanned photographing device 1090. For example, when the user drags the second jog button 1020 in a direction 1041, the electronic device 1000 may analyze a drag direction and a drag distance and send information about forward movement and movement velocity to the unmanned photographing device 1090. Next, the movement control module of the unmanned photographing device 1090 may control the propellers 910 and 920 to rotate at a greater RPM than the RPM of the propellers 930 and 40 according to the velocity information. The unmanned photographing device 1090 may move forward in a direction 1051. When the user touches and drags the second jog button 1020 in a direction 1043, the unmanned photographing device 1090 may rotate the propellers 930 and 940 faster than the propeller 910 and 920 and move backward in a direction 1053.

When the user touches and drags the second jog button 1020 in a direction 1045, the unmanned photographing device 1090 may rotate the propellers 910 and 940 faster than the propeller 920 and 930 and move to the left in a direction 1055. When the user touches and drags the second jog button 1020 in a direction 1047, the unmanned photographing device 1090 may rotate the propellers 920 and 930 faster than the propeller 910 and 940 and move to the right in a direction 1057.

FIG. 10B depicts vertical movement control of the drone of the unmanned photographing device 1090. For example, when the user drags the first jog button 1010 in a direction 1061, the electronic device 1000 may analyze a drag direction and a drag distance and send information about upward movement and movement velocity to the unmanned photographing device 1090. Next, the unmanned photographing device 1090 may move upward by increasing the RPM of the propellers 910 through 940 at the same time according to the velocity information of the unmanned photographing device 1090. When the user touches and drags the first jog button 1010 in a direction 1063, the unmanned photographing device 1090 may move downward by reducing the RPM of the propellers 910 through 940.

FIG. 10C depicts yaw rotation control. The yaw may indicate the direction change of the unmanned photographing device 1090. The unmanned photographing device 1090 may differently control the rotation direction of the propellers 910 and 930 and the propellers 920 and 940 as shown in FIG. 9B. For example, when the user drags the first jog button 1010 in a direction 1071, the unmanned photographing device 1090 may control to spin the propellers 910 and 930 clockwise faster in RPM than the propellers 920 and 940 which are spinning counterclockwise, and turn to the right. When the user drags the first jog button 1010 to a direction 1073, the unmanned photographing device 1090 may control to spin the propellers 920 and 940 counterclockwise faster in RPM than the propellers 910 and 930 which are spinning clockwise, and turn to the left.

Flight of the unmanned photographing device 1090 may be controlled by the user using the first jog button 1010 or the second jog button 1020 of the electronic device 1000. The unmanned photographing device 1090 may autonomously fly. The unmanned photographing device 1090 may enter the auto photographing mode. In the auto photographing mode, the unmanned photographing device 1090 may autonomously fly to the photographing position based on photographing information received from the electronic device 1000 as shown in FIG. 6. When the photographing position is determined, the unmanned photographing device 1090 may autonomously fly to a target photographing position by controlling the throttle, the pitch, the roll, and/or the yaw as shown in FIGS. 10A, 10B and 10C.

An electronic device according to an embodiment of the present disclosure may include a housing, a display unit exposed through at least part of the housing, at least one wireless communication unit, a processor electrically connected to the display and the communication circuit, and a memory electrically connected to the processor. The memory may store one or more photos. The memory may store instructions, when executed, causing the processor to display one or more on the display, to receive a user input indicating preference of at least one photo, to store information about the preference in the memory, to extract at least one parameter based on at least part of the at least one photo and the information, to send the at least one parameter to an external imaging device through the wireless communication unit so as to autonomously fly to a certain position based on part of the at least one parameter, and to receive a photo captured at the position from the external imaging device.

The processor may display parameters of images captured by the external imaging device, and generate photographing information comprising the image parameters determined based on the user preference.

The parameters may be photographing information comprising photographing position information which is coordinate information based on a subject.

The processor may generate the photographing information based on a parameter of an image reflecting a preference received through a network service.

The processor may set the photographing information based on at least one of sharing information, search history, the number of times of visiting an image, and evaluation information of others.

An external imaging device according to an embodiment of the present disclosure may include a housing, a navigation device attached to or integrated with the housing, and flying an electronic device to a three-dimensional position, at least one wireless communication device, a camera attached to or integrated with the housing, a processor electrically connected to the navigation device, the communication device, and the camera, and a memory electrically connected to the processor and storing instructions. The processor may establish wireless a connection with an external electronic device comprising a display using the wireless communication device, receive a parameter from the external electronic device through the wireless connection, the parameter extracted based on at least part of at least one photo and information, control the navigation device to autonomously fly to a set position based on the parameter, capture an image using the camera, and send the image to the external electronic device through the wireless connection.

The external imaging device may be an unmanned aerial vehicle, and the processor may confirm a photographing position based on the parameter, take off at an image of a subject position by controlling the navigation device and recognizes an image of a subject, autonomously fly from the subject position to the photographing position, and capture the subject by controlling the camera at the photographing position.

The photographing position may be a three-dimensional coordinate value based on the subject.

The parameter may further include camera control information for controlling a camera angle, and the processor may control the camera angle based on the camera information such that a camera module faces the subject at the photographing position.

When finishing the photographing, the processor may land an external imaging device by controlling the navigation device.

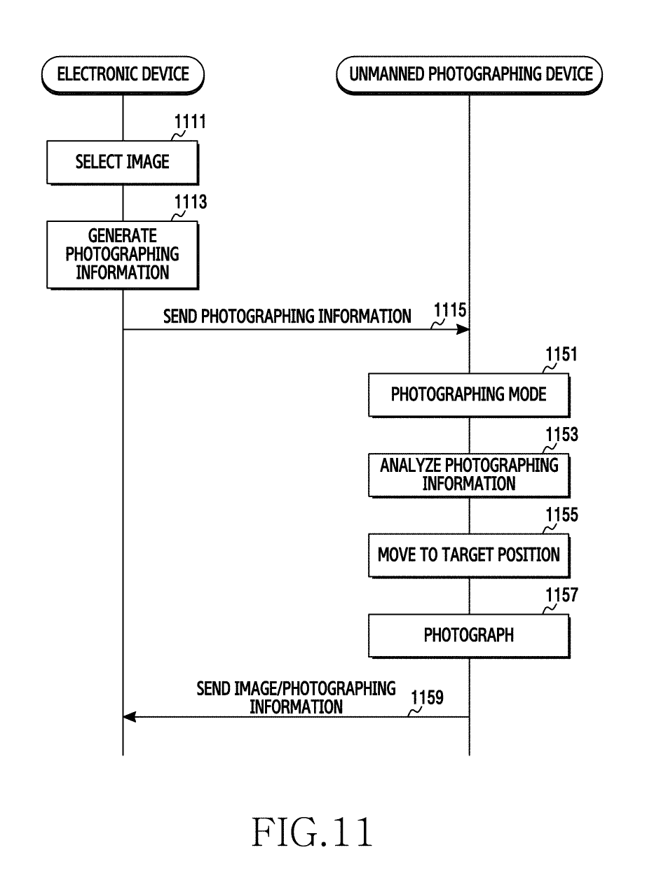

FIG. 11 is a flow diagram of a photographing method of an unmanned photographing device according to an embodiment of the present disclosure.

Referring to FIG. 11, the user may select a favorite photo from an album of an electronic device, or select an image of high preference using a network service (e.g., SNS). For example, the image may be captured by the unmanned photographing device. The electronic device recognizes the image selection in step 1111. In step 1113, the electronic device generates photographing information of the selected image. The photographing information of the image captured by the unmanned photographing device may include photographing position information. Beside the photographing position information, the photographing information may further include metadata (e.g., exif), composition information, and/or camera control information. In step 1115, the electronic device sends the generated photographing information to the unmanned photographing device. The photographing information transmitted to the unmanned photographing device may include at least part of the photographing information corresponding to the selected image based on the user preference.

The unmanned photographing device may be a drone. Upon receiving the photographing information, the unmanned photographing device sets the auto photographing mode in step 1151. Next, the unmanned photographing device may also receive photographing information from the electronic device. The photographing information may include metadata (e.g., exif) and the photographing position information. For example, the metadata may include camera setting values such as camera model, lens, aperture, shutter speed, international organization for standardization (ISO), white balance (WB), light metering, focal length, filter, and effects. The photographing position information may be position information (e.g., absolute coordinates) of the subject captured by the unmanned photographing device. The photographing information may include the photographing position information of the unmanned photographing device and various information such as metadata. When storing the image, the unmanned photographing device may also store the photographing information so as to reproduce the composition and the impression of the picture. For example, the photographing information may further include composition information and/or camera control information.

The photographing position information in the photographing information may be the absolute coordinates based on the subject. Reference coordinates may be set to define a certain position in space. A coordinate system for defining the position in a 3D space may include an origin of coordinate axes and three orthogonal coordinate axes X, Y, and Z. The absolute coordinates indicate an intersection of each direction coordinate based on the origin, and may be a fixed coordinate point. For example, only one absolute coordinate point may exist in the space. Relative coordinates may indicate an intersection of each direction based on a final point (the absolute coordinates are based on the origin). Accordingly, the relative coordinates have only one mark but corresponding coordinates may be indefinite based on the reference point.

The electronic device according to an embodiment of the present disclosure may set the subject position as the origin and set the subject photographing position of the unmanned photographing device as the absolute coordinates.

After receiving the photographing information, the unmanned photographing device may confirm the photographing position by analyzing the photographing information in step 1153. The unmanned photographing device locates the subject and move to the target photographing position by controlling the movement module 520 in step 1155. For example, for the selfie shot, the unmanned photographing device may hover and locate the subject (the reference point) and autonomously fly from the subject position to the photographing position (the absolute coordinate position based on the subject) of the photographing information.

In step 1155, the unmanned photographing device automatically takes a picture by controlling the camera module 560. When capturing the subject, the unmanned photographing device may focus according to a preset composition of the image by controlling the camera module 560. For example, for a center focus, the unmanned photographing device may focus on the center of the subject by controlling the camera module 550 and adjust the camera direction in the preset composition after the focusing. When capturing the subject, the unmanned photographing device may adjust the camera angle according to the camera control data. For example, when the camera module 550 is at the eye level with the subject (when the unmanned photographing device and the subject are at the same position horizontally), the unmanned photographing device may maintain the camera angle. When the camera module 550 is higher than the subject (when the unmanned photographing device is higher than the subject), the unmanned photographing device may adjust the camera angle to a high angle. When the camera module 550 is lower than the subject (when the unmanned photographing device is lower than the subject), the unmanned photographing device may adjust the camera angle to a low angle.

In step 1159, the unmanned photographing device sends complex image information including the captured image and the photographing information to the electronic device. After the auto shooting, the unmanned photographing device may return to its original position. For example, when the unmanned photographing device is the UAV, the original position may be a landing location of the unmanned photographing device.

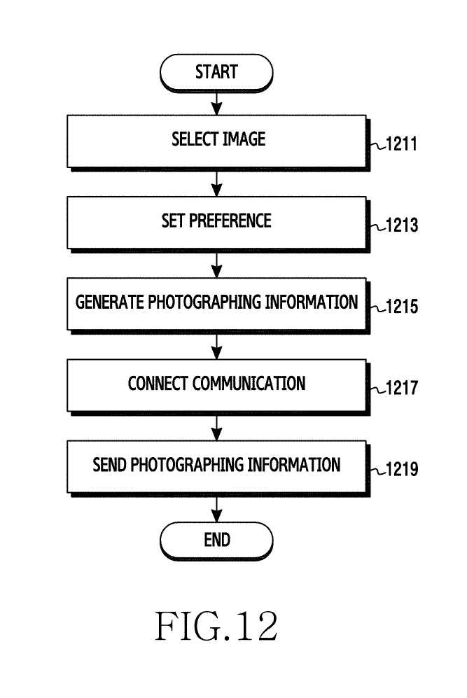

FIG. 12 is a flowchart of a method for processing photographing information in an electronic device according to an embodiment of the present disclosure.

Referring to FIG. 12, the electronic device selects an image in step 1211. In step 1213, the electronic device sets a preference of the selected image. For example, when the user selects an image from an album, the electronic device may display a UI/UX for determining the preference on the display 450, and set photographing information of the selected image based on the preference selected by the user. For example, the electronic device may receive an image through a network service. The image received through the network service may include photographing information. For example, the electronic device may receive an image and photographing information through the network service, and determine a preference of the corresponding image using preference information of the image. Next, the unmanned photographing device generates photographing information based on the preference in step 1215.

According to an embodiment of the present disclosure, the electronic device may independently set the preference and generate/transmit the photographing information. For example, the user may set preference of images captured by the unmanned photographing device. When taking a picture through the unmanned photographing device, the electronic device may display images based on the determined preference (priority), and send the photographing information of the image selected by the user from the displayed image to the unmanned photographing device.

In the photographing mode using the unmanned photographing device, the electronic device is wirelessly connected with the unmanned photographing device through the communication unit 420 in step 1217. In step 1219, the electronic device sends the photographing information generated based on the preference, to the unmanned photographing device. For example, using Bluetooth communication connection, the electronic device may attempt to pair with the unmanned photographing device through a BT communication unit. When the pairing is done, the electronic device may send the preference-based photographing information to the unmanned photographing device.

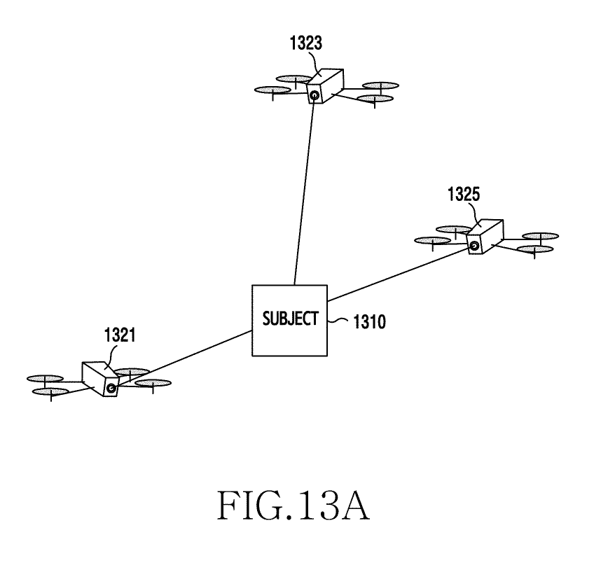

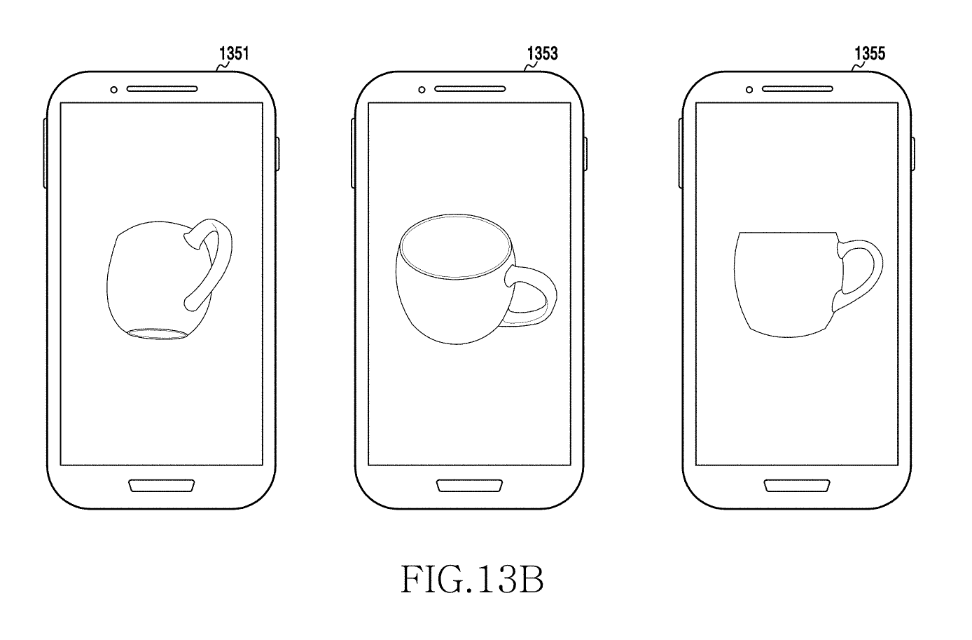

FIGS. 13A and 13B are diagrams of images based on a photographing position of an unmanned photographing device according to an embodiment of the present disclosure.

The unmanned photographing device may capture an image of a subject 1310 in a 3D space as shown in FIG. 13A. Photographing position information in photographing information transmitted to the unmanned photographing device may include a 3D absolute coordinate value. For example, the unmanned photographing device may capture the subject 1310 at positions 1321, 1323, and 1325 in the 3D space. Accordingly, when capturing the same subject 1310, the unmanned photographing device may take images 1351, 1353, and 1355 of FIG. 13B at different angles according to its photographing position. In FIG. 13B, the images are taken at various photographing positions of the unmanned photographing device and transmitted to the electronic device, and the images received from the unmanned photographing device at the electronic device are displayed differently according to the photographing position.

The unmanned photographing device may capture the subject 1310 at the various positions 1321, 1323, and 1325 based on the subject 1310, and store complex image information including the captured images and photographing information which includes the photographing position information, composition information, and/or camera control information. According to an embodiment of the present disclosure, the photographing information may include absolute coordinate information based on the subject 1310. The unmanned photographing device may send the complex image information to the electronic device, and the electronic device may store the received complex image information in the storage unit 410 (e.g., an album, a gallery, etc.). The user may select an image stored in the album of the electronic device and thus determine preference.

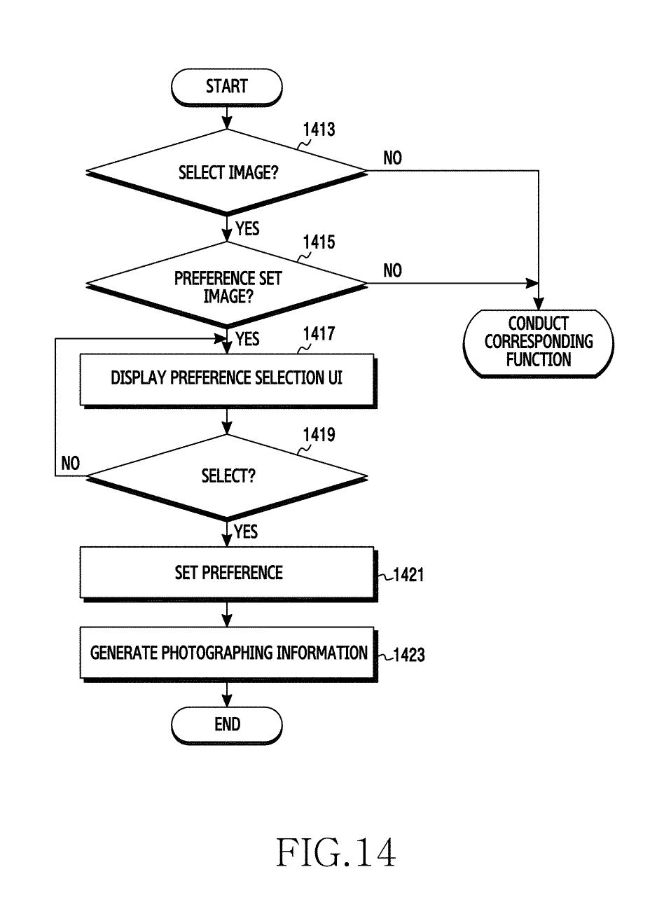

FIG. 14 is a flowchart of a method for determining a preference of an image by selecting an image in an electronic device according to an embodiment of the present disclosure.

Referring to FIG. 14, the electronic device may set a preference of images taken by the unmanned photographing device. The electronic device may have a preference setting mode. Upon selecting the preference setting mode, the electronic device may display a UI for determining the preference when displaying the selected image. When an image taken by the unmanned photographing device is selected, the electronic device may display an icon for setting the preference. When the image is displayed and the icon is selected, the electronic device may display a UI for selecting the preference for the selected image.

The image taken by or received at the unmanned photographing device (the image taken by the unmanned photographing device or the image received from the unmanned photographing device or the network service) may include photographing information including photographing position information. When the user selects an image stored in the storage unit 410, the electronic device recognizes the selection in step 1413. In step 1415, the electronic device analyzes whether the preference of the selected image may be set. When the image may select the preference, the electronic device displays a UI for setting the preference on the display 450 in step 1417. When the user selects the preference in the displayed UI, the electronic device recognizes the selection in step 1419 and sets the preference selected by the user as the preference of the corresponding image in step 1421. Next, the electronic device generates photographing information based on the preference in step 1423.

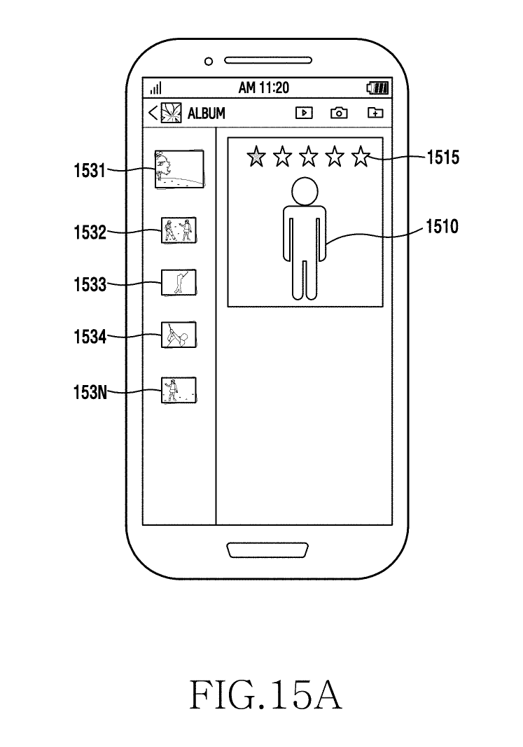

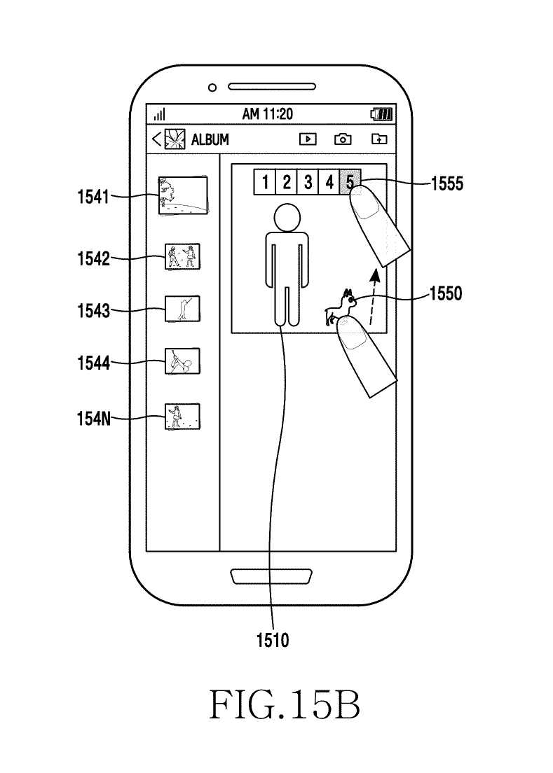

FIGS. 15A and 15B are screenshots of an electronic device which sets preference of a selected image according to an embodiment of the present disclosure.

When capturing an image of a subject, an unmanned photographing device may obtain an image and position information of the captured image. An application (e.g., an album) for viewing the captured picture in the electronic device may provide a UI/UX which offer a user a preference input function for images captured in various situations. The preference may be indicated in various fashions such as relative scores of 1, 2, 3, 4, . . . , representative values of high, mid, and low, and preference comment of good or bad. The collected user preference information may be analyzed and utilized in various manners.

When executing the application for the preference input, the electronic device may display a UI for selecting the preference as shown in FIG. 15A. In FIG. 15A, an image 1510 may be selected, a UI 1515 may select the preference, and thumbnail images 1531 through 153 N may be used to select a preference image. When the user selects the intended preference level in the preference UI 1515, the electronic device may recognize the selection and determine the preference of the displayed image 1510.

When setting the preference, the electronic device may provide a UI for selecting preference of a particular object in the selected image 1510 as shown in FIG. 15B. For example, the particular object 1550 in the selected image 1510 may be a puppy. When the user selects the particular object 1550 (e.g., the puppy) through the UI 1555 displayed in the image including the particular object 1550, the electronic device may display the preference for the image including the selected object 1550. According to an embodiment of the present disclosure, the electronic device may independently set the preference of the selected image 1510 and the preference of the particular object 1550 of the image 1510 in FIG. 15B. When one image includes a plurality of objects, the electronic device may set the preference per object.

Thumbnail images 1541 through 154 N may be thumbnail images of images (e.g., images stored in the album) stored in the electronic device. Such images may include one or more objects. When the image includes one object, the electronic device may display the preference input UI as shown in FIG. 15A and set the image preference based on the user selection. When the image includes two or more objects, the electronic device may set the preference of the image as shown in FIG. 15A and may set the preference of the image and the objects in the image respectively as shown in FIG. 15B. When detecting the object of the determined preference at the photographing position (coordinate (composition) position information of the photographing spot), the unmanned photographing device may take a picture at a corrected position so as to cover the corresponding object.

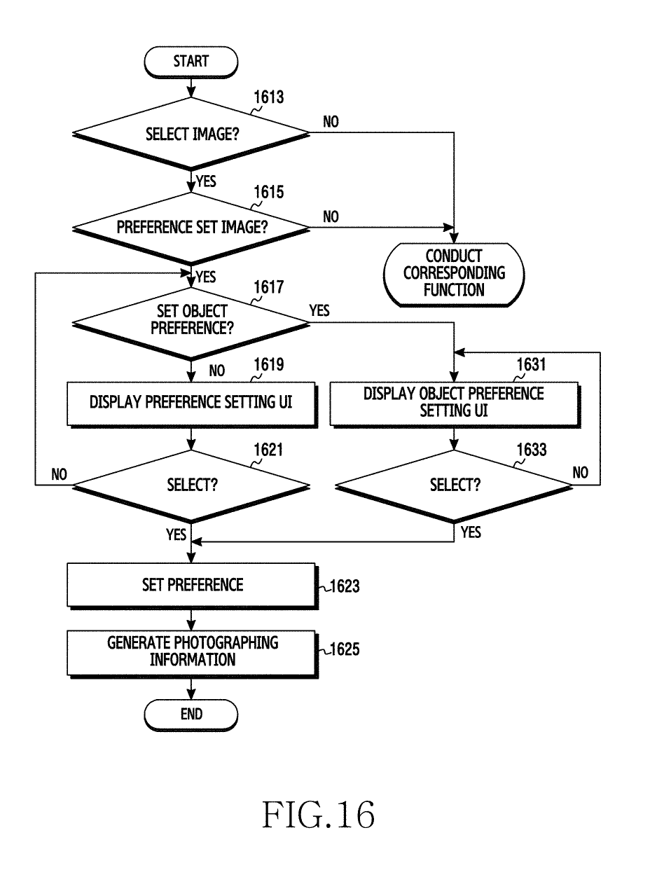

FIG. 16 is a flowchart of a method for determining an object preference of a selected image in an electronic device according to an embodiment of the present disclosure.

Referring to FIG. 16, when an image is selected in step 1613, the electronic device analyzes a preference set image in step 1615. When determining the preference set image, the electronic device analyzes whether the image may set object preference in step 1617. When the image does not set the object preference, the electronic device displays a preference setting UI in step 1619. When the preference is selected, the electronic device recognizes the selection in step 1621 and determines the preference selected by the user as the preference of the corresponding image in step 1623. In step 1625, the electronic device generates photographing information based on the determined preference.

When the selected image sets the object preference in step 1617, the electronic device displays an object preference setting UI in step 1631. When the object preference is selected, the electronic device recognizes the selection in step 1633 and determines the preference selected by the user as the preference of the corresponding image in step 1623. In step 1625, the electronic device generates photographing information based on the determined preference.

When taking a picture using the unmanned photographing device, the electronic device may take the picture at a set position by manually or automatically controlling the unmanned photographing device, and obtain the image from the unmanned photographing device. In the image capture, the unmanned photographing device may store photographing information together with the image. The photographing information may include the photographing position (e.g., a coordinate value based on the subject), a camera angle, and a camera setting value (e.g., exif). When the user views the photo, the electronic device may display the UI for setting the user preference and update the photographing position information with the preference selected by the user. For example, when the preference is based on the score of 1, 2, 3 . . . , the user may select the score and thus update new coordinate information of the photographing position.

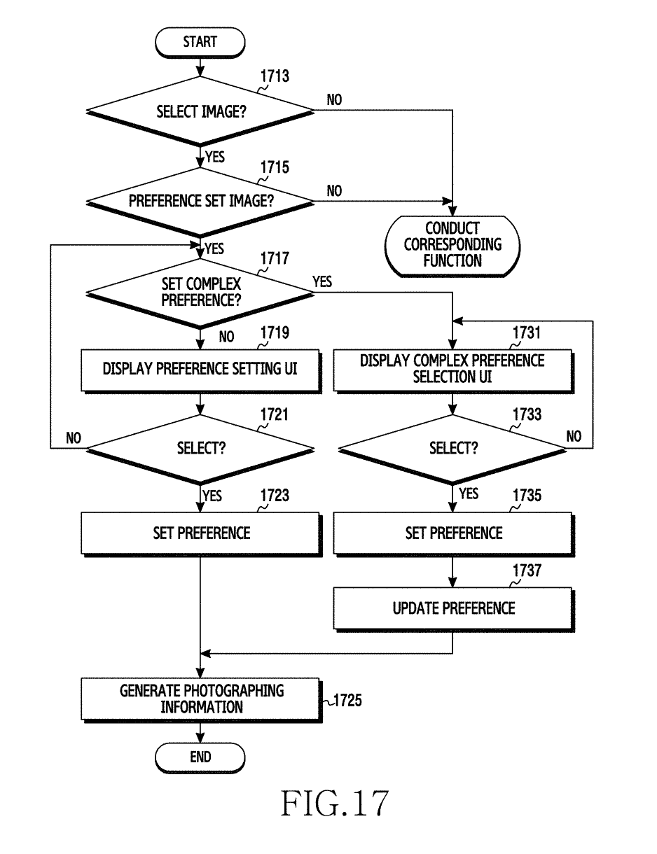

FIG. 17 is a flowchart of a method for updating a photographing position in an electronic device according to an embodiment of the present disclosure.

Referring to FIG. 17, when an image is selected in step 1713, the electronic device analyzes a preference set image in step 1715. When determining the preference set image, the electronic device analyzes the image for complex preference setting in step 1717. A method for setting the complex preference may set the preference by weighting two or more images. For example, the electronic device may set the preference for two images respectively and generate photographing information based on the determined preference weight.

When determining no image for the complex preference setting, the electronic device displays a preference setting UI as shown in FIG. 15A in step 1719. When the preference is selected, the electronic device recognizes the selection in step 1721 and determines the preference selected by the user as the preference of the corresponding image in step 1723. In step 1725, the electronic device generates photographing information based on the set preference.

When determining the selected image for setting the complex preference in step 1717, the electronic device displays a UI for selecting the complex preference in step 1731. The complex preference may set the preference for at least two images. According to an embodiment of the present disclosure, a plurality of images for setting the complex preference may be taken from the same subject or in the same time zone. When the complex preference is selected, the electronic device recognizes the selection in step 1733 and calculates the complex preference as one preference in step 1735.

The electronic device updates the preference according to the calculated preference in step 1737, and updates the photographing information based on the updated preference in step 1725. For example, when the preference of the images may be set based on the score (e.g., the preference may be set to 1, 2, 3 . . . ). When the user sets the preference of each image, the images may have different preferences. The electronic device may update new photographing information (e.g., the photographing position information) based on the preference of the images.

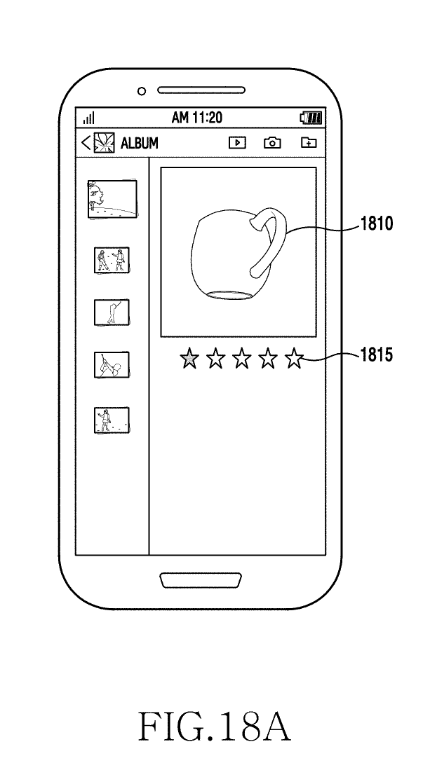

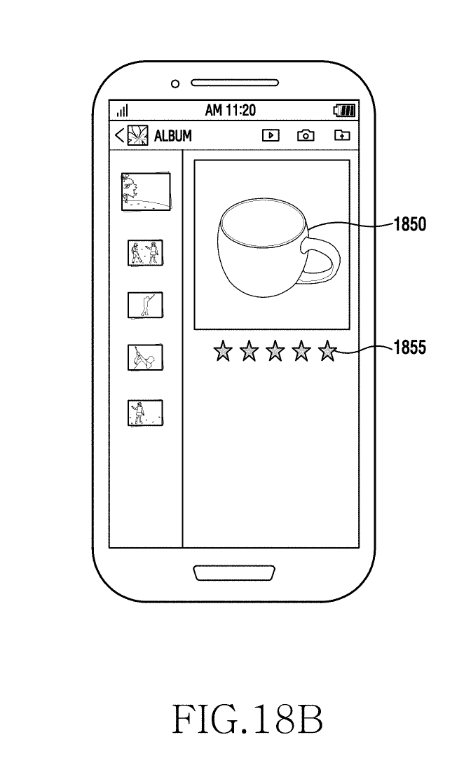

FIGS. 18A and 18B are screenshots of an electronic device which sets complex preference according to an embodiment of the present disclosure.

FIGS. 18A and 18B show an example of preferences set by the user for two images. For example, when the user selects a first image and a second image and sets different preferences of the first image and the second image, the electronic device may define new photographing position coordinates for the two images according to Equation (1).

$$New coordinate = \frac{\begin{matrix}( coordinates of first image ) \times preference of first image + \\ ( coordinate of second image ) \times preference of second image\end{matrix}}{sum of preferences of first image and second image} \qquad ( 1 )$$

In FIG. 18A, preference 1815 of a first image 1810 may be expressed as a number 1. In FIG. 18B, preference 1855 of a second image 1850 may be expressed as a number 5. The electronic device may generate new photographing position information with a preference weight of the two images based on Equation (2) below. In the preference information based on the score, the numbers may be set in various manners. For example, numbers below five or numbers over five may be used.

$$New coordinate = \frac{( pic {1}^{′} s coordinate ) \times 1 + ( pic {2}^{′} s coordinate ) \times 5}{6} \qquad ( 2 )$$

The new photographing position information ( 3D coordinate information) acquired from the preference-based calculation using Equation (2) may be used as coordinates for the movement (e.g., flight) and the photographing position in the auto photographing mode.

According to an embodiment of the present disclosure, when updating the photographing position information, the electronic device may set the preference of each image and then update it with the preference of the complex image. For example, the electronic device may calculate the preference of the first image 1810 and the second image 1850 individually in steps 1719 through 1723, and then determine the complex preference of the images in steps 1731 through 1737.

According to an embodiment of the present disclosure, when updating the photographing position information and requiring the complex preference, the electronic device may display the available images as thumbnail images. When the user selects a plurality of images and sets the preference for each of the selected images, the electronic device may determine the complex preference of the selected images based on Equation (1). The coordinate generation based on the preference information (e.g., the score) of the image may reflect the complex preference of the user and provide the new photographing position based on the preference, rather than the previous position.

According to an embodiment of the present disclosure, the images taken at the same position or in the same time zone (or time range, e.g., AM 10:00 AM 11:00 etc) may be selected as target images for the preference calculation and used to generate the new coordinates.

The new coordinate information (the updated coordinate information) in FIG. 18A and 18 B may be used as the photographing position of the unmanned photographing device. The image taken by the unmanned photographing device may be stored with the photographing information including the photographing position information. According to an embodiment of the present disclosure, when the captured image is viewed in the unmanned photographing device, the electronic device may update the new photographing position information according to the preference selected by the user. For example, the embodiment for the score-based priority may consistently update the user's desired photographing position based on the user preference, rather than a constant photographing position. For the new coordinate information updating, various advanced analysis methods such as supervised learning, unsupervised learning, and deep learning algorithm may be adopted. The coordinate information obtained from the picture may be excluded from, or included in, the analysis according to time information. For example, data collected several months ago may be excluded, and only recent data may be used to upgrade the coordinate information.

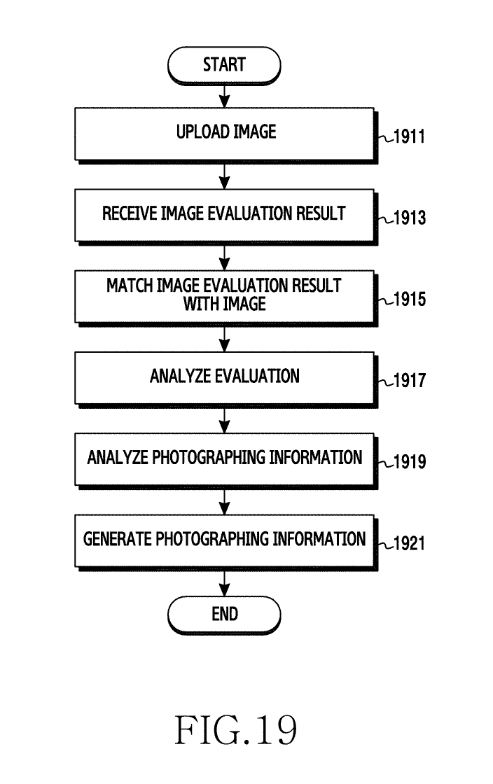

FIG. 19 is a flowchart of a method for setting preference in association with a network service in an electronic device according to an embodiment of the present disclosure.

Referring to FIG. 19, user's preference may be collected using various methods. For example, beside the preference setting by the user's selection, a plurality of preferences selected by others may be reflected in the photographing. For example, a web-based image uploading service such as SNS may generate the photographing information based on assessment of the photo captured by the unmanned photographing device.

In step 1911, the electronic device uploads an image to a network service. For example, the network service may be an SNS. When the image is uploaded to the SNS, other users may assess (set the preference) the uploaded image. For example, other users may view and evaluate (e.g., like) the uploaded image.

After a certain time passes, the electronic device receives the evaluation result of the uploaded image in step 1913 and matches the image evaluation result to the corresponding image in step 1915. In step 1917, the electronic device analyzes the evaluation result (e.g., the number of likes from the other users). The electronic device analyzes the image photographing information in step 1919 and reflects the analyzed preference in the photographing information in step 1921.

The SNS may include various data (photos) reflecting preference of multiple users. In particular, the user may collect recommendations and assessment of other users with respect to the image uploaded on the web, match them to images stored in a drone or a cellular phone, analyze composition information and features of the corresponding image, and directly use them for autonomous photographing composition information or to correct previous autonomous photographing composition information.

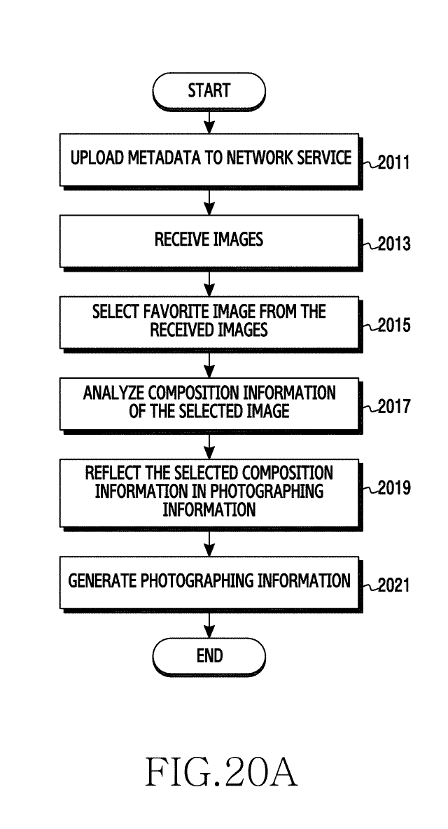

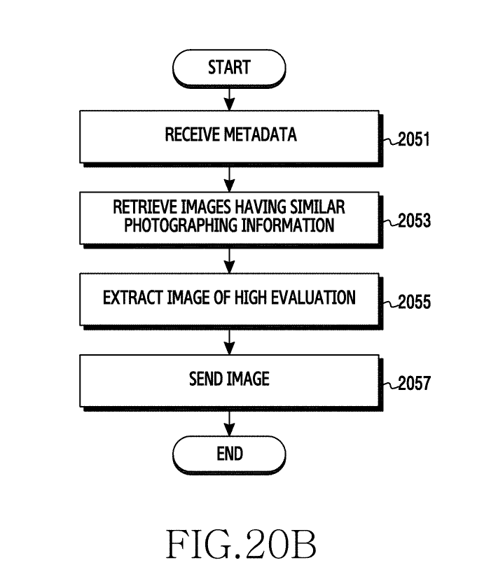

FIG. 20A is a flowchart of a method for setting photographing information by collecting information of network service in an electronic device according to an embodiment of the present disclosure.

Referring to FIG. 20A, the electronic device may acquire metadata of other images taken in the same photographing position as the automatic shooting using the unmanned photographing device. For example, at a famous shooting place, the electronic device may provide recommended composition by extracting and analyzing images taken by the unmanned photographing device with many recommendations on a network service (e.g., SNS). The electronic device may acquire preference-based photographing coordinates from a particular group under various conditions such as place and position, and utilize them as photographing coordinates of the auto photographing mode using the unmanned photographing device. The electronic device uploads the metadata of the photographing place to the network service in step 2011. The metadata of the photographing place may include the place and the time.

In step 2013, the electronic device receives images and photographing information rated high in the network service. In step 2015, the electronic device displays the received images and select the photographing information based on the image selected by the user.

The electronic device analyzes the selected photographing information (e.g., composition information) in step 2017 and reflects the selected composition information in the photographing information in step 2019. For example, the electronic device may set the photographing information of the image including the user's intended composition information, as the photographing information of the auto photographing mode. The determined photographing information may include the photographing information of the image with the user's intended composition information.

According to an embodiment of the present disclosure, the electronic device may set the preference of the image received from the network service. The method for setting the preference may include the method for setting the preference of the image, the method for setting both the preference of the image and the preference of the particular object of the image, and the method for setting preference of multiple images individually and generating new photographing information based on the weight of the preferences.

FIG. 20B is a flowchart of a method for transmitting an image and photographing information in a network service according to an embodiment of the present disclosure.

Referring to FIG. 20B, the network service (e.g., a server) receives metadata from the unmanned photographing device in step 2051. The network service may search for images having similar photographing information to the received metadata based on the received metadata in step 2053. The metadata may include information such as photographing time and place. The network service may search the images taken by the unmanned photographing device for images including the received metadata. In step 2055, the network service extracts images of the photographing information (e.g., composition information) rated high from the retrieved images. In step 2057, the network service transmits the extracted image and photographing information to the electronic device. The photographing information transmitted to the electronic device may include the position information of the captured image (e.g., 3D absolute coordinate information).

According to an embodiment of the present disclosure, the electronic device may search the network service for images taken by the unmanned photographing device at the photographing position, download the photographing information of the highly rated image from the network service, and thus utilize them as the auto photographing information.

The electronic device in FIGS. 20A and 20B may link and configure a menu through the preference information gathering using the SNS, and generate the photographing information enabling the drone photography by providing user-customized information and a customized menu.

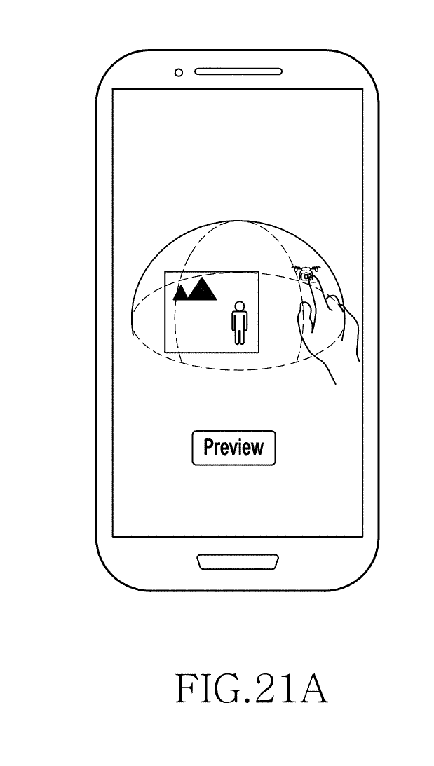

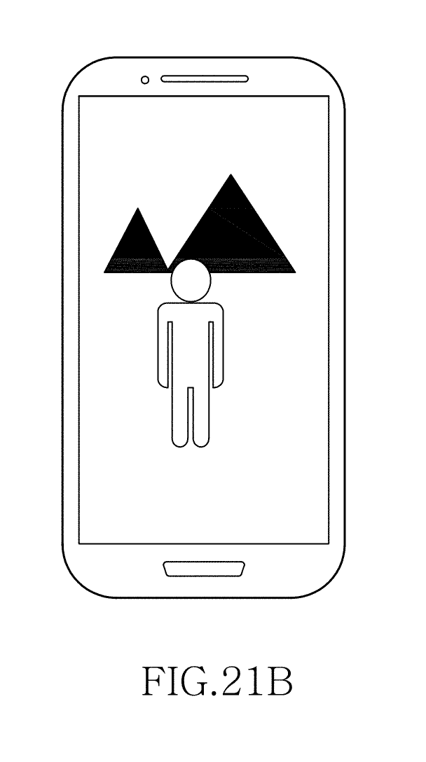

FIGS. 21A and 21B are screenshots of an electronic device which creates photographing information by changing metadata of an image according to an embodiment of the present disclosure.

Using 3D-scanning or 3D-modeling data of a real space or location-based server data, the photographing position may be selected using a 3D map application and a virtual photo may be previewed. Composition or coordinate information selected through the application may be forwarded to the unmanned photographing device (e.g., a drone) and used as information for actual image capture. The unmanned photographing device receiving the composition or coordinate information of the 3D map application may control the unmanned photographing device to take a corresponding photo. Various applications for supporting the drone photography may be provided.

When the user modifies metadata (e.g., zoom magnification) in the 3D map application of FIG. 21A, the electronic device may generate photographing information by modifying the photographing position information. For example, when selecting the photographing position in the 3D map application as shown in FIG. 21A, the electronic device may generate and store a movement path of the unmanned photographing device so as to take a picture with corresponding composition as shown in FIG. 21B. The movement path may be used as the position information of the auto photographing. The photographing information may be generated to set diagonally upward and downward directions and/or a size of a person.

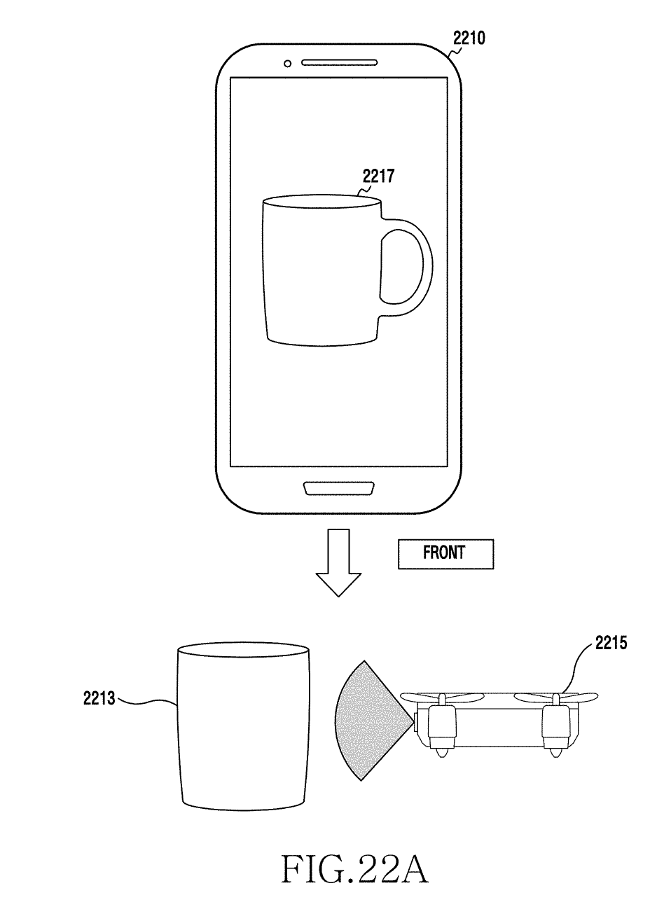

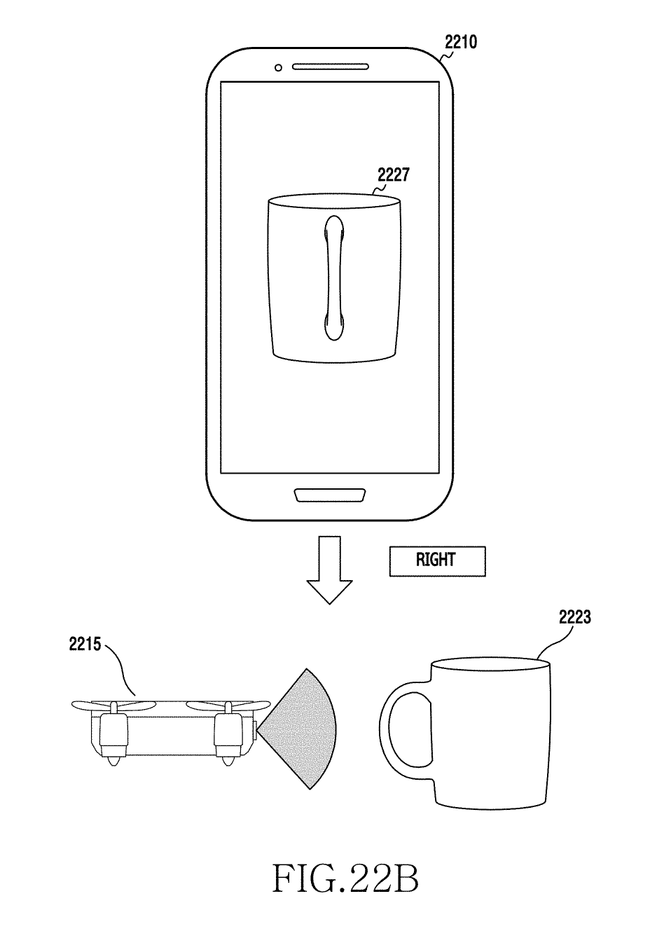

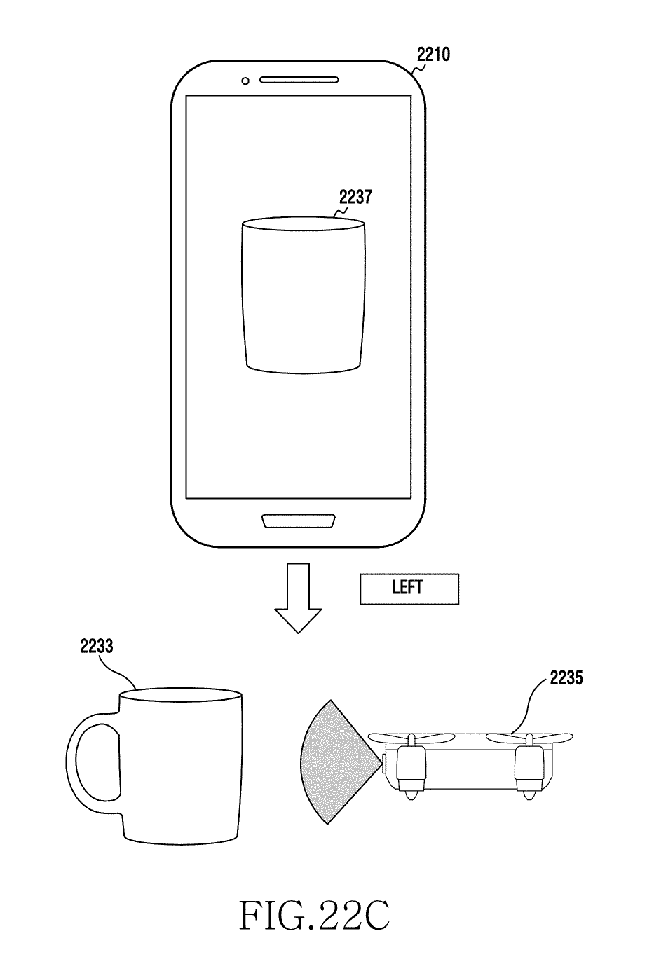

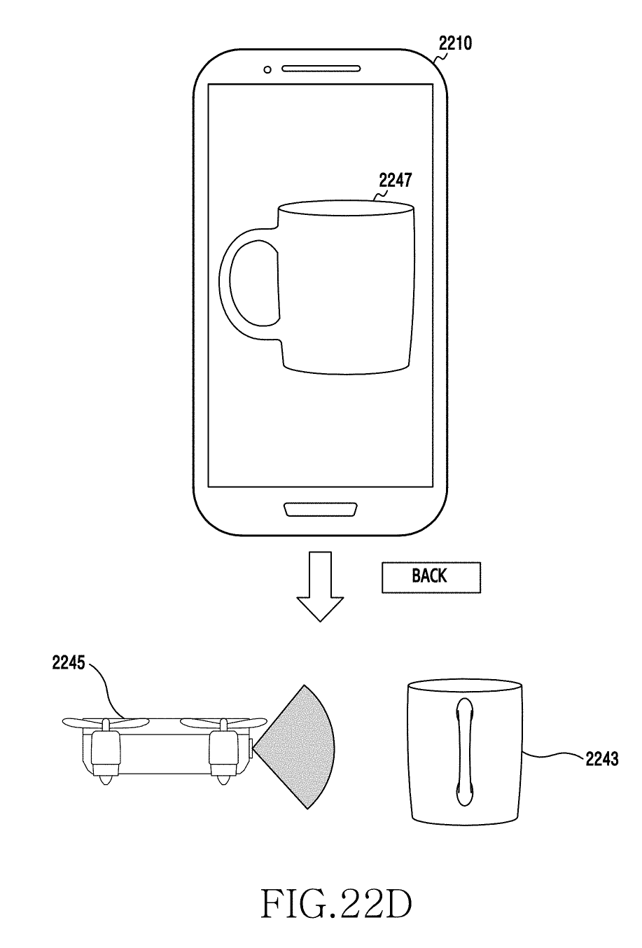

FIGS. 22A, 22B, 22C and 22D are diagrams of an electronic device which sets a plurality of photographing positions using a 3D application according to an embodiment of the present disclosure.

In FIG. 22A, an unmanned photographing device 2215 is positioned in front of an image of a subject 2213, and an electronic device 2210 may generate photographing information for taking a front image 2217. In FIG. 22B, the unmanned photographing device 2215 is positioned on a right side of an image of a subject 2223, and the electronic device 2210 may generate photographing information for taking a right-side image 2227. In FIG. 22C, the unmanned photographing device 2215 is positioned on a left side of an image of a subject 2333, and the electronic device 2210 may generate photographing information for taking a left-side image 2237. In FIG. 22D, the unmanned photographing device 2215 is positioned at the back of an image of a subject 2243, and the electronic device 2210 may generate photographing information for taking a rear-side image 2247.

The photographing information including the composition or coordinate information selected through the application as shown in FIGS. 21A and 21B and FIGS. 22A through 22D may be generated, and the generated photographing information may be sent to the unmanned photographing device and used as the information for the actual photographing. The unmanned photographing device receiving the composition or coordinate information of the application may control the drone, the camera and/or the gimbal in order to capture a corresponding picture. The application for supporting the drone photographing may be provided in various types.

The photographing using the unmanned photographing device may collect the image and various photographing information such as photographing position information, composition coordinate information, and nearby object. Such photographing information may include factors which determine the user's favorite photo. According to an embodiment of the present disclosure, when user preference for such factors may be obtained and the unmanned photographing device may automatically take a picture based on the user preference, the user's favorite photo may be acquired more easily. The user preference information may be collected through various application UI/UXs such as photo album of a smart phone. For example, a weight per priority based on the preference may applied to height or horizontal angle information based on a user's face, calculated with the accumulated data, and utilized as the composition and direction information for the autonomous photographing.

The electronic device may generate the preference-based photographing information in various manners. The electronic device may generate the photographing information by reflecting the user preference in the image selected by the user. The electronic device may set the photographing information by using the photographing information of the high-preference image (the image taken by the unmanned photographing device) of other users in the network service. The electronic device may search for images taken by other users at the photographing position in association with the network service at the time of the photographing, and generate the photographing information by downloading photographing information including intended image composition. The electronic device may generate the photographing information by use of photographing information taken by other devices or photographing information of an intended image from a server. The electronic device may automatically take a picture using a 3D application which enables simulations. The electronic device may provide functions for selecting the photographing position and previewing a virtual photo using a 3D map application through the 3D scanning or 3D modeling data of the actual space or the position-based server data.

The unmanned photographing device in the auto photographing mode may use the preference-based photographing information (e.g., coordinate, composition information of the photographing position) received from the electronic device, for the image capture. The photographing information may be updated when the unmanned photographing device and the electronic device are communicating (e.g., paired), and the photographing information updated in the electronic device may be forwarded to the unmanned photographing device in real time. According to an embodiment of the present disclosure, the preference-based photographing information may be the coordinate information from an image of a subject (e.g., the user in the selfie mode) recognition point. After recognizing the subject, the unmanned photographing device may automatically move to the coordinates of the photographing position of the photographing information and take a picture.

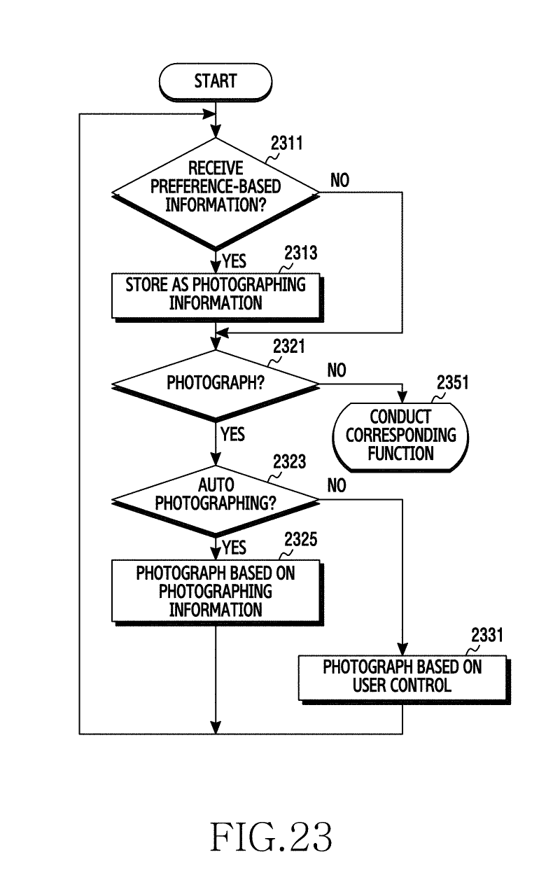

FIG. 23 is a flowchart of steps of an unmanned photographing device according to an embodiment of the present disclosure.

Referring to FIG. 23, when the unmanned photographing device is connected with an electronic device, it may receive information from the electronic device or transmit its captured image and photographing information to the electronic device. Upon receiving preference based information from the electronic device, the unmanned photographing device recognizes the reception in step 2311 and stores the photographing information in step 2313. Next, the electronic device proceeds to step 2321.

According to an embodiment of the present disclosure, upon receiving the photographing information, the electronic device may be configured. When the auto photographing is set, the electronic device may store the received preference-based photographing information received and automatically take a picture based on the received photographing information.

According to an embodiment of the present disclosure, the electronic device may separately execute the photographing information reception and the photographing. When the photographing information reception and the photographing are set independently, the electronic device stores the received photographing information and then performs a corresponding function in step 2351.

The unmanned photographing device may select a photographing mode according to user selection. Alternatively, when the electronic device receives the photographing information, the unmanned photographing device may enter the auto photographing mode. In the photographing mode, the unmanned photographing device recognizes the photographing mode in step 2321 and analyzes the auto photographing mode or a manual photographing mode in step 2323. In the auto photographing mode, the unmanned photographing device takes a picture based on the photographing information in step 2325. When the auto photographing mode is set, the unmanned photographing device may perform the auto photographing based on the most recent photographing information received among the photographing information. When the auto photographing mode is set, the unmanned photographing device may perform the auto photographing based on photographing information with the highest preference among the photographing information. In step 2325, the unmanned photographing device autonomously flies to the photographing position of the photographing information and automatically takes a picture. The photographing position information in the photographing information may be 3D coordinate information, and the coordinate information may be flight coordinates (X, Y, Z) from a reference point (e.g., an image of a subject). The unmanned photographing device captures an image based on the photographing information and stores the captured image in step 2325. Also, the unmanned photographing device may send the captured image to the electronic device.

When recognizing the manual photographing mode in step 2323, the unmanned photographing device takes a photo based on the control of the electronic device in step 2331. In the manual photographing mode, the electronic device may control a flight attitude of the unmanned photographing device using a first jog button and a second jog button. The unmanned photographing device may fly based on the flight attitude control of the electronic device. For example, the manual photographing mode may be a video shooting mode.

According to an embodiment of the present disclosure, the electronic device may control the photographing mode of the unmanned photographing device. For example, the electronic device may send the photographing information and an auto photographing control command. The unmanned photographing device may receive the received photographing information, and autonomously fly and photograph based on the received photographing information according to the auto photographing control command. In the auto photographing mode, the unmanned photographing device may take off (e.g., lift off) for the auto photographing, and then set the reference point by detecting or recognizing an image of a subject (e.g., a user's face). The reference point may be the initial coordinates of the flight, and the reference point may be set to a position at a certain distance by calculating the number of pixels of the user face. The photographing position may be 3D coordinates (X, Y, Z) from the reference point. After recognizing the subject, the unmanned photographing device may autonomously fly to the photographing position based on the received photographing information and capture an image of intended composition at the photographing position. The unmanned photographing device may store and send the captured image to the electronic device. After the auto photographing, the electronic device may autonomously fly to and land on the takeoff position.

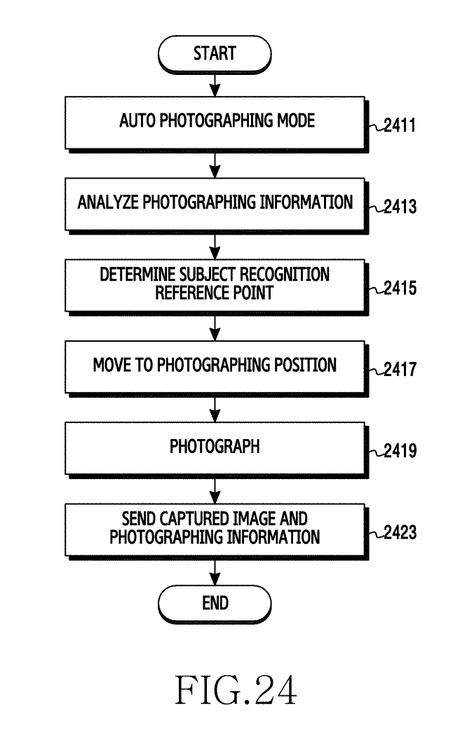

FIG. 24 is a flowchart of auto photographing operations of an unmanned photographing device according to an embodiment of the present disclosure.

Referring to FIG. 24, the unmanned photographing device sets an auto photographing mode in step 2411. For example, when receiving photographing information, the unmanned photographing device may enter the auto photographing mode. For example, when the user or an external device sets the auto photographing mode, the unmanned photographing device may enter the auto photographing mode.

In step 2413, the unmanned photographing device analyzes the photographing information received from the electronic device. The photographing information may include photographing position information, and may further include driving and/or camera control information.

In step 2415, the unmanned photographing device recognizes an image of a subject and sets a reference point of the auto photographing. For example, for the selfie shot, the unmanned photographing device may hover around and recognize the user and determine a position of the recognized user as the reference point in step 2415.

In step 2417, the unmanned photographing device flies to the determined reference point based on the photographing position information. The photographing position information may be a 3D coordinate value based on the subject.

After arriving at the photographing position, the unmanned photographing device automatically takes a picture in step 2419. Upon arriving at the photographing position, the unmanned photographing device may indicate start of the photographing (e.g., display using an indicator, sound audio using an audio module 770). The photographing start indication may be maintained for a certain time, and the user may make an intended pose.

In step 2423, the unmanned photographing device sends the captured image and the photographing information to the electronic device. Also, after taking the picture, the unmanned photographing device may autonomously fly to and land on the original position (e.g., the takeoff point, the hovering position, etc.).

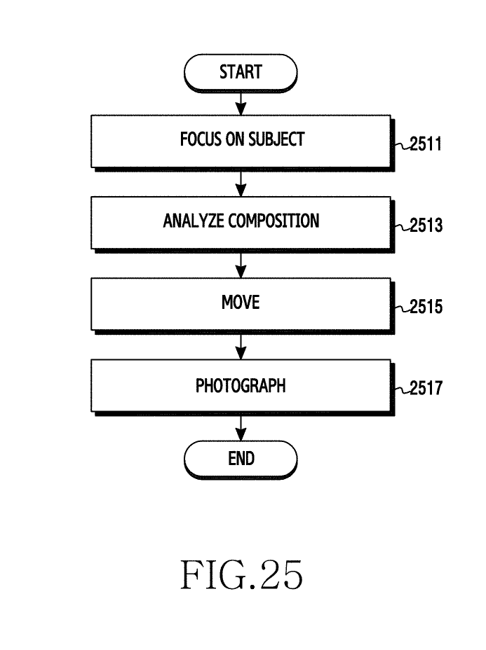

FIG. 25 is a flowchart of automatic photographing operations of an unmanned photographing device according to another embodiment of the present disclosure.

Referring to FIG. 25, when arriving at a photographing position, the unmanned photographing device may automatically take a picture based on photographing information. The photographing information may include position information and/or composition information of a main subject. When the main subject is a moving object (e.g. a person or an animal), it may be outside the photographing position.

In step 2511, the unmanned photographing device focuses on the subject by controlling the camera module 560. After focusing, the unmanned photographing device may analyze composition of the subject within a region (e.g., a screen region) of the entire image. For example, the unmanned photographing device analyzes the position (e.g., composition) of the subject in the screen region of the image (e.g., preview image, live image) acquired by the camera module 560 in step 2513. The subject composition analysis may determine whether or not the subject is located on a boundary of the screen region. The photographing information may include the subject position information (e.g., composition information) in the screen region. For example, with the subject position information in the screen region, the subject composition information of the image region may be obtained. The unmanned photographing device may compare and analyze the image acquired by the camera module 560 and the subject position information of the photographing information.

In step 2515, the unmanned photographing device moves based on the analysis result of the composition of the image acquired by the camera module 560. For example, when the subject is on the screen boundary, the unmanned photographing device may move such that the subject is placed within the screen region (e.g., not on the screen boundary). For example, when the subject in the image acquired by the camera module 560 is not placed at the subject position of the photographing information, the unmanned photographing device may move so that the subject is placed at the position in the screen region.

When taking the image of the determined composition, the unmanned photographing device focuses on the subject and automatically photographs in step 2517. The image of the set composition may be the image of the composition in the screen region. The image of the set composition may be the image having the subject composition information based on the subject photographing information (e.g., the image placing the subject at the screen position determined by the composition information). When the subject of the screen region is at the set position in the composition analysis in step 2513, the unmanned photographing device may omit the movement of step 2515. The camera module 560 may include an optical unit (e.g., lens), an image sensor, an image signal processor, and a camera controller. The image signal processor may be included in the application processing module 500. The unmanned photographing device may hover around, recognize the subject, move to the target photographing position, and then take a picture.

Since the photographing position is determined by 3D coordinates, the unmanned photographing device may be placed over or under the subject, or alongside the subject. The camera module 560 of the unmanned photographing device may be disposed underneath the unmanned photographing device as shown in FIG. 9A. The unmanned photographing device according to an embodiment of the present disclosure may adjust the angle of the camera module 560 based on the camera control data of the photographing information. When the photographing position is eye level with the subject, the unmanned photographing device may adjust the camera angle so that the camera module 560 may capture the subject at eye level of the subject. When the photographing position is higher than the subject, the unmanned photographing device may adjust the camera angle (to a high angle) such that the camera shoots the subject downward from above. When the photographing position is lower than the subject, the unmanned photographing device may adjust the camera angle (to a low angle) such that the camera looks up at the subject. The camera control information in the photographing information may be eye level, high angle, or low angle information. When focusing on the subject at the photographing position, the unmanned photographing device may analyze the camera control information (or the direction toward the subject at the photographing position), adjust the camera angle according to the analysis, and then focus on the subject.

The captured image may have a different screen composition according to a position and a size of the subject. For example, when the subject is a person, the person in the image may be placed on the left side, at the center, or on the right side of the screen. The person in the image may be of various sizes. A full shot may take the entire image of the person, a knee shot may take parts covering from a knee to a head of the person, a waist shot may take parts covering from a waist to the head of the person, a bust shot may take parts covering from a bust to the head of the person, an up-shot (close-up shot) may take a close-up image of a face, and a big close-up shot may take a particular portion (e.g., a lip, an eye, a noise, an ear, etc.) of the face.

The photographing information may include the image composition information. The composition information may include the subject position information and subject size information in the screen. The composition information may include center position information of the subject in an image screen (e.g., aspect ratio 16:9, 4:3, 3:2, etc.), and the subject size information. After focusing, the unmanned photographing device analyzes the position and the size of the subject by analyzing the composition information in step 2513. When movement is required, the unmanned photographing device moves in step 2515 and takes a picture in step 2517.

In the selfie shot, the subject may be a person. For the person, the camera module 560 may apply a center focus mode. In the center focus mode, the unmanned photographing device may focus on the subject by placing it at the center in step 2511, change the screen composition in steps 2513 and 2515, and then take a picture in step 2517.

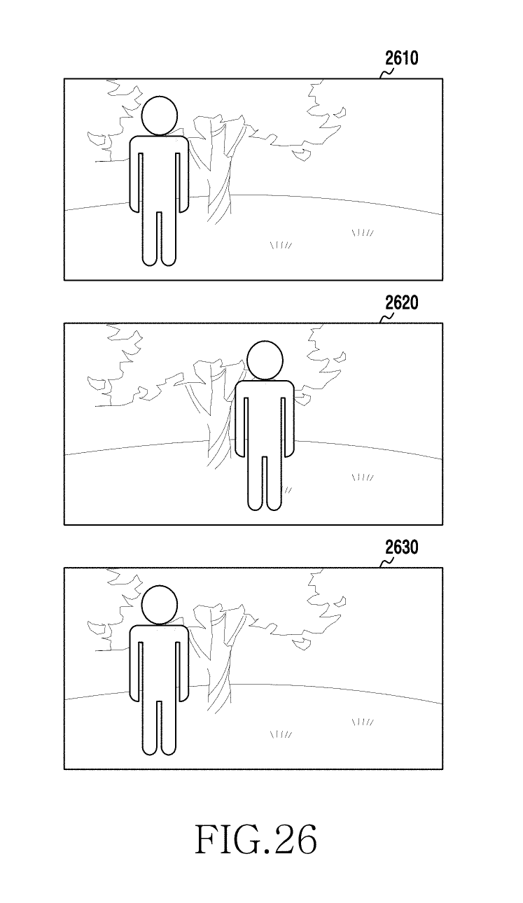

FIG. 26 is a diagram of an unmanned photographing device which photographs by changing composition in a center focus mode according to an embodiment of the present disclosure.

In FIG. 26, an intended image (e.g., an image of high preference) to be captured by the unmanned photographing device may be an image 2610. When a focusing mode of a camera of the unmanned photographing device is the center focus mode, the unmanned photographing device may focus on a person 2620 at the center. The unmanned photographing device may analyze a position and a size of the subject by analyzing the composition information, and, when requiring movement or camera control, take an image 2630 by controlling the movement control module or the camera module.

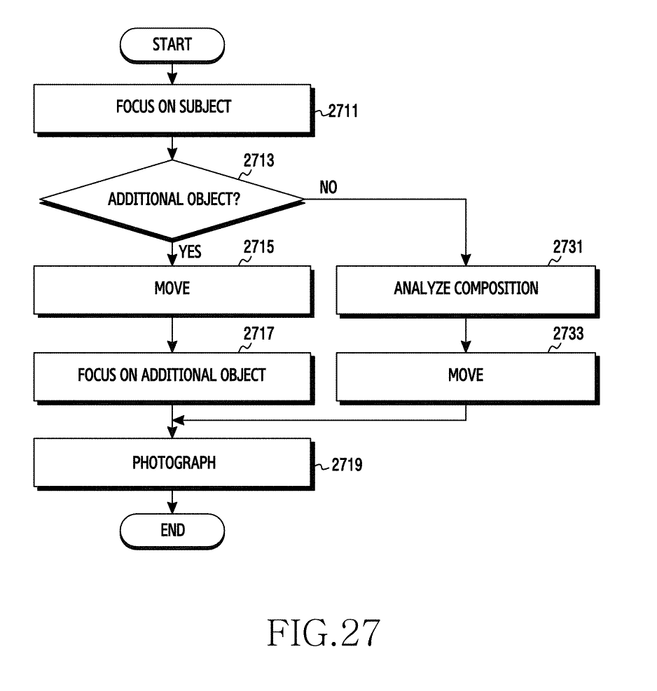

FIG. 27 is a flowchart of operations of an unmanned photographing device which photographs by including an additional object according to an embodiment of the present disclosure.

An electronic device according to an embodiment of the present disclosure may generate photographing information including additional object information. The photographing information may include preference information of the additional object. For example, the user may set the additional object (e.g., an animal) as shown in FIG. 15B.

Referring to FIG. 27, after arriving at a photographing position, the unmanned photographing device focuses on the subject in step 2711. In step 2713, the unmanned photographing device determines whether an additional object exists by analyzing the photographing information.

When determining the additional object in step 2713, the unmanned photographing device changes the composition (e.g., moves) to cover the additional object in step 2715. Next, the unmanned photographing device focuses on subjects including the additional object in step 2717 and then automatically takes a picture in step 2719.

According to an embodiment of the present disclosure, the photographing information received at the unmanned photographing device may include image preference and additional object preference. When receiving the photographing information including the additional object preference, the unmanned photographing device focuses on the subject in step 2711. Based on the received photographing information, the unmanned photographing device detects the presence of the additional object in step 2713. Next, the unmanned photographing device moves and focuses on the additional object in steps 2715 and 2717. For a single object, the unmanned photographing device may focus on the subject in the center focus mode. For multiple objects, the unmanned photographing device may focus on the objects in a multi-focus mode. For example, when focusing on the subject, the unmanned photographing device may switch the focus mode to the multi-focus mode in order to focus on the additional object.

According to an embodiment, when recognizing another object in the screen composition, the unmanned photographing device may determine the additional object. Referring to FIG. 27, when focusing on the subject in step 2711 and detecting another object in the screen composition, the unmanned photographing device determines the additional object in step 2713. For example, when the screen includes another object and the unmanned photographing device automatically photographs, only part of the object on the boundary of the screen may be captured. Upon detecting the additional object, the unmanned photographing device changes the composition and/or the focus mode to cover the additional object in step 2715, focus on the subjects including the additional object in step 2717, and then automatically take a picture in step 2719.

When detecting no additional object in step 2713, the unmanned photographing device analyzes the composition information of the photographing information in step 2731, moves according to the analyzed composition in step 2733, and then automatically take a picture in step 2719.

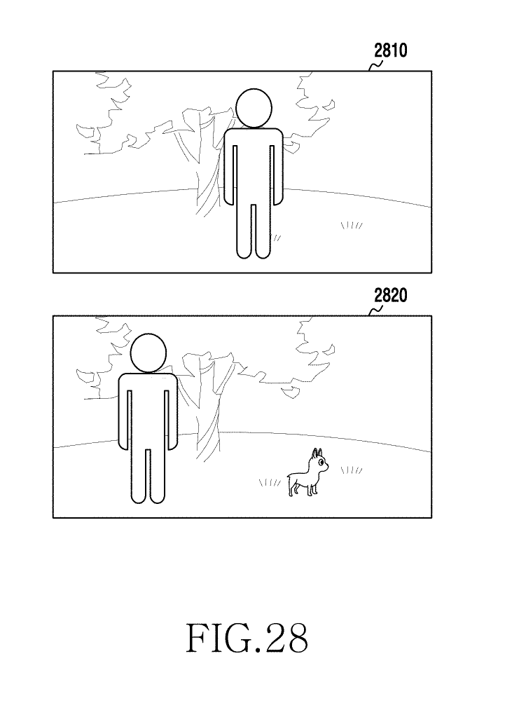

FIG. 28 is a diagram of an unmanned photographing device which photographs when an additional object is included according to an embodiment of the present disclosure.

When determining a photographing position, the unmanned photographing device may identify an image of a subject and then autonomously fly to the photographing position. At the photographing position, the unmanned photographing device may focus in step 2810. When an additional object exists, the unmanned photographing device may move, reset the composition to cover the additional object, and then take a picture in step 2820.

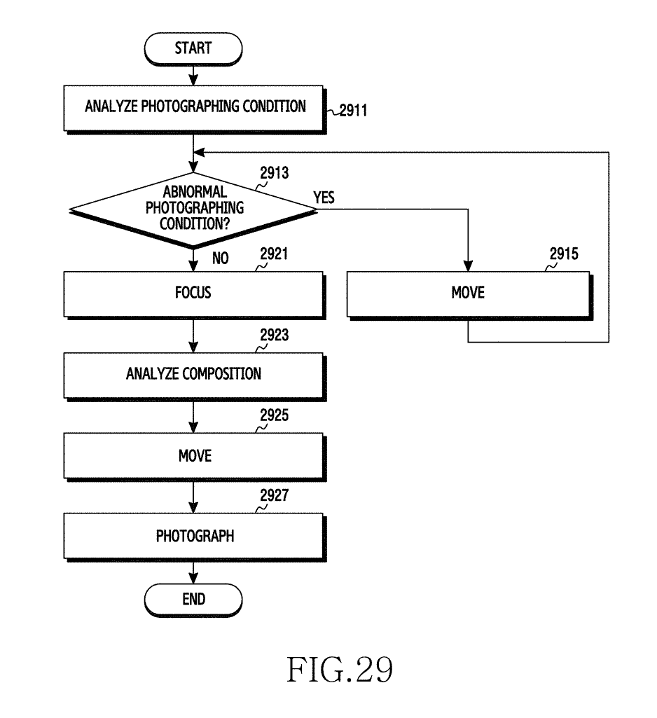

FIG. 29 is a flowchart of operations of an unmanned photographing device which photographs under an abnormal photographing condition according to an embodiment of the present disclosure.

Referring to FIG. 29, the unmanned photographing device may automatically photograph based on preference-based photographing information. The unmanned photographing device in the photographing mode may recognize an image of a subject according to the preference-based photographing information and autonomously fly to a photographing position. According to an embodiment of the present disclosure, the unmanned photographing device may fly to the photographing position and then change the photographing position according to a photographing condition. For example, the photographing condition may be a light source. When taking a picture, the light source may be quite important. The light source may include front lighting which illuminates an image of a subject (e.g., a camera is interposed between the light source and the subject), side lighting which illuminates the subject at a 90-degree angle to the side, back lighting which illuminates the subject from the back (e.g., the subject is interposed between the light source and the camera), and plain lighting which illuminates the subject at a 45-degree angle to the side. Since the camera faces the light source in the back lighting, the captured subject may be taken relatively dark. Accordingly, it may be advantageous to take a picture using the front lighting, the plain lighting, or the side lighting by moving the camera unless the back lighting is intentionally applied.

After analyzing the photographing condition in step 2911, under an abnormal photographing condition (e.g., the back lighting), the unmanned photographing device recognizes such a condition in step 2913 and moves to a position of the normal photographing condition (e.g., front lighting, plain lighting, side lighting, etc.) in step 2915. Upon moving to the position of the normal photographing condition, the unmanned photographing device recognizes the normal condition in step 2913 and focuses by controlling the camera module 560 in step 2921. The unmanned photographing device analyzes the composition in step 2923, moves to the analyzed composition in step 2925, and then automatically takes a picture in step 2927.

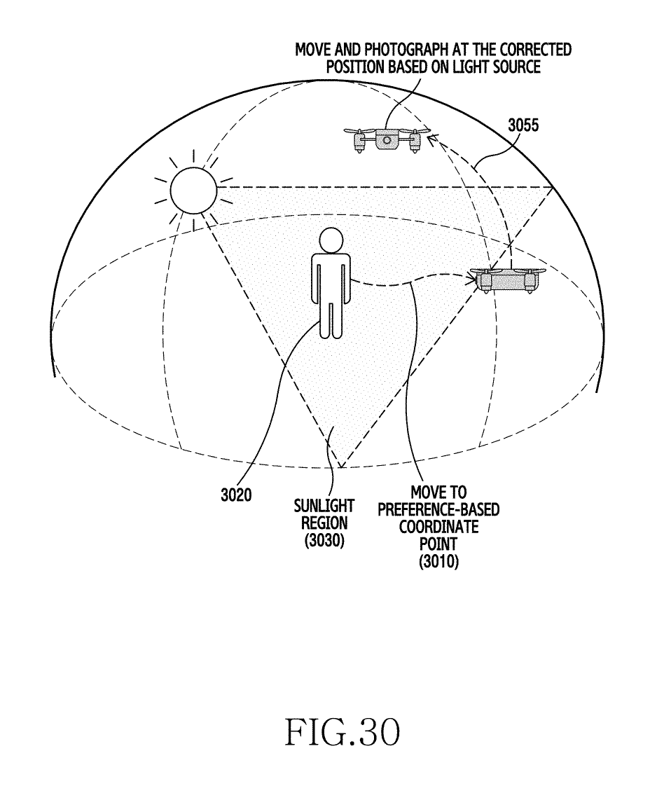

FIG. 30 is a diagram of an unmanned photographing device which photographs by considering a light source according to an embodiment of the present disclosure.

Referring to FIG. 30, when a photographing position is determined according to preference-based photographing information, the unmanned photographing device may confirm the photographing position of an image of a subject 3020 and move to a target photographing position 3010. The unmanned photographing device may collect surrounding environment information at the photographing position and analyze the collected information.

For example, the photographing information may be set the preference based on the composition, based on the subject, and based on a background or an additional object. The unmanned photographing device may take a picture according to a calculated value as intended by the user (e.g., the preference). According to an embodiment of the present disclosure, the unmanned photographing device may analyze the surrounding information (or environment information) and then determine whether to correct its position (move). When the surrounding information (or environment information) is abnormal, the unmanned photographing device may display the abnormal state to the user and guide the user to change the position or direction. For example, when detecting the abnormal photographing condition, the unmanned photographing device may send abnormal photographing condition information to the electronic device.

According to an embodiment of the present disclosure, the abnormal photographing condition may be the back lighting. When the subject 3020 is interposed between the unmanned photographing device (e.g., the photographing direction of the camera module) and the sunlight in a sunlight region 3030, the unmanned photographing device may recognize the back lighting condition based on an output of a sensor module (e.g., an illumination sensor). When the back lighting is not intentional, the unmanned photographing device may determine the abnormal photographing condition in step 2913, move to a corrected position 3055 (e.g., a position for taking a picture with the front light, the side light, or the plain light) by considering the light source in step 2915, and then take a picture.

According to an embodiment of the present disclosure, in the abnormal photographing condition, the unmanned photographing device may take a first image in the corresponding photographing condition, move to the corrected position, and then take a second image. For example, in the back lighting, the unmanned photographing device may take a first image against the light, move to a position out of the back lighting by considering the light source, and then take a second image.

The image and the photographing information may be transmitted from the unmanned photographing device to the electronic device. The electronic device may obtain complex image information (the image and the photographing information) received from the unmanned photographing device in real time or after a certain time after the photographing. The user may confirm the image and the photographing information of the unmanned photographing device received at the electronic device, and determine the user preference for the image and the photographing information through an application of the electronic device. In the photographing mode using the unmanned photographing device, the electronic device may generate the photographing information (for example, the photographing position coordinates, the composition, and the surroundings) based on the user's preference and send the photographing information to the unmanned photographing device. The unmanned photographing device may enter the auto photographing mode using the photographing information received from the electronic device.

The unmanned photographing device in the auto photographing mode may utilize the photographing information based on the user preference received from the electronic device, for the photography. The photographing information may be updated when the unmanned photographing device and the electronic device are electrically connected, and may be transferred to the unmanned photographing device in real time when the electronic device updates the photographing information. According to an embodiment photographing information, the preference-based information may be the coordinate information from the subject (user) recognition point. The unmanned photographing device may recognize the subject (user) in the auto photographing mode, move to coordinates of a pre-stored photographing position, and then take a picture.

An operating method of an electronic device includes displaying one or more photos on a display, receiving a user input indicating a preference of at least one photo, storing information about the preference in a memory, extracting at least one parameter based on at least part of the at least one photo and the information, sending the at least one parameter to an external imaging device through a wireless communication unit so as to autonomously fly to a certain position based on part of the at least one parameter, and receiving a photo captured at the position from the external imaging device.

Extracting the parameter includes displaying parameters of images captured by the external imaging device, and generating photographing information comprising the image parameter set based on the user preference.

The parameter may be photographing information including photographing position information which is coordinate information based on an image of a subject.

The operating method further includes receiving an image reflecting the preference through a network service.

Generating the photographing information may extract from the received parameter the parameter based on at least one of sharing information, search history, the number of times for visiting an image, and evaluation information of other users.

The external imaging device establishes wireless connection with the electronic device, receive a parameter from the electronic device through the wireless connection, the parameter extracted based on at least part of at least one photo and information, control a navigation device to autonomously fly to a set position based on the parameter, capture an image using a camera, and send the image to the electronic device through the wireless connection.

The external imaging device may be an unmanned aerial vehicle, and controlling the navigation device includes confirming a photographing position based on the parameter, taking off at an image of a subject position and recognizing an image of a subject, and autonomously flying from the subject position to the photographing position.

The photographing position may be a three-dimensional coordinate value based on the subject.

The parameter further includes camera control information for controlling a camera angle, and capturing the image further includes controlling the camera angle based on the camera information such that a camera module faces the subject at the photographing position.

The operating method further includes, when finishing the photographing, landing the external imaging device by controlling the navigation device.

As set forth above, according to an embodiment, the unmanned photographing device captures an image by reflecting the user preference in association with an application of a mobile communication device.

While the present disclosure has been described with reference to certain embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
a display unit exposed through at least part of the housing;
at least one wireless communication unit;
a processor electrically connected to the display unit and the at least one wireless communication circuit; and
a memory electrically connected to the processor,
wherein the memory stores one or more photos, and
the memory stores instructions, which when executed, cause the processor to:
display one or more photos on the display,
receive a user input indicating a preference of at least one photo,
store information about the preference in the memory,
determine at least one parameter based on at least part of the one or more photos and the preference information,
send the at least one parameter to an external imaging device through the wireless communication unit to autonomously fly the external imaging device to a set position based on part of the at least one parameter, and
receive an image captured at the position from the external imaging device.

2. The electronic device of claim 1, wherein the processor is configured to display parameters of images captured by the external imaging device, and generate photographing information comprising the image parameters determined based on the preference information.

3. The electronic device of claim 2, wherein the parameters are photographing information comprising photographing position information based on coordinate information of a subject.

4. The electronic device of claim 1, wherein the processor is configured to generate the photographing information based on a parameter of an image reflecting preference information received through a network service.

5. The electronic device of claim 4, wherein the processor is further configured to set the photographing information based on at least one of sharing information, a search history, a number of times for viewing an image and evaluation information.

6. An external imaging device comprising:
a housing; a navigation device attached to or integrated with the housing;
at least one wireless communication device;
a camera attached to or integrated with the housing;
a processor electrically connected to the navigation device, the at least one wireless communication device and the camera; and
a memory electrically connected to the processor and storing instructions, which when executed, cause the processor to:
establish a wireless connection with an electronic device having a display using the at least one wireless communication device,
receive a parameter from the electronic device through the wireless connection, the parameter based on at least part of at least one photo and information,
control the navigation device to autonomously fly the external imaging device to a set position based on the parameter,
capture an image using the camera, and
send the image to the electronic device through the wireless connection.

7. The external imaging device of claim 6, wherein the external imaging device is an unmanned aerial vehicle, and
the processor is configured to;
confirm a photographing position based on the parameter,
control the navigation device,
recognize a subject,
autonomously fly from a position of the subject to the photographing position, and
capture an image of the subject by controlling the camera at the photographing position.

8. The external imaging device of claim 7, wherein the photographing position is a three-dimensional coordinate value based on the position of the subject.

9. The external imaging device of claim 7, wherein the parameter comprises camera control information for controlling a camera angle, and
the processor is further configured to control the camera angle based on the camera control information such that a camera module faces the subject at the photographing position.

10. The external imaging device of claim 7, wherein, after capturing the image of the subject, the processor is further configured to land the external imaging device by controlling the navigation device.

11. An operating method of an electronic device, comprising:
displaying one or more photos on a display;
receiving a user input indicating a preference of at least one photo;
storing information about the preference in a memory;
determining at least one parameter based on at least part of the at least one photo and the information;
sending the at least one parameter to an external imaging device through a wireless communication unit;
autonomously flying the external imaging device to a set position based on part of the at least one parameter; and
receiving an image captured at the set position from the external imaging device.

12. The operating method of claim 11, wherein determining the parameter comprises:
displaying parameters of images captured by the external imaging device; and
generating photographing information comprising an image parameter set based on the preference.

13. The operating method of claim 12, wherein the parameter is photographing information comprising photographing position information based on a position of a subject.

14. The operating method of claim 11, further comprising:
receiving an image reflecting the preference through a network service.

15. The operating method of claim 14, wherein the information about the preference is based on at least one of sharing information, a search history, a number of times for viewing an image and evaluation information.

16. The operating method of claim 11, further comprising, establishing, by the external imaging device, a wireless connection with the electronic device;
receiving a parameter from the electronic device through the wireless connection, the parameter determined based on at least part of at least one photo and the preference information;
controlling a navigation device to autonomously fly the external imaging device to a set position based on the parameter;
capturing an image using a camera; and
sending the image to the electronic device through the wireless connection.

17. The operating method of claim 16, wherein the external imaging device is an unmanned aerial vehicle; and
wherein controlling the navigation device comprises:
confirming a photographing position based on the parameter;
recognizing a subject; and
autonomously flying from the subject position to the photographing position.

18. The operating method of claim 17, wherein the photographing position is a three-dimensional coordinate value based on the position of the subject.

19. The operating method of claim 17, wherein the parameter comprises camera control information for controlling a camera angle, and
wherein capturing the image comprises:
controlling the camera angle based on the camera control information such that a camera module faces the subject at the photographing position.

20. The operating method of claim 17, further comprising:
landing the external imaging device by controlling the navigation device after capturing the image.
